(19) United States
(12) Patent Application Publication
(10) Pub. No.: US 2025/0382419 A1
(43) Pub. Date: Dec. 18, 2025

(54) DISULFIDATED POLYMERS AND METHODS OF PREPARATION

(71) Applicant: The Regents of the University of Colorado, a Body Corporate, Denver, CO (US)

(72) Inventors: Christopher N. Bowman, Boulder, CO (US); Marianela Trujillo-Lemon, Boulder, CO (US); Benjamin Fairbanks, Broomfield, CO (US)

(21) Appl. No.: 19/236,359

(22) Filed: Jun. 12, 2025

Related U.S. Application Data
(60) Provisional application No. 63/660,098, filed on Jun. 14, 2024.

(51) Int. Cl. C08G 75/0268; G02B 1/00

(52) U.S. Cl. CPC C08G 75/0268; G02B 1/00

(57) ABSTRACT

The present disclosure describes polymer compositions obtained from cyclic 1,2-disulfides and alkyne monomers, which result in materials with optically useful properties. The disclosure also describes synthetic methods for making these polymer compositions.

### CROSS-REFERENCE TO RELATED APPLICATION

This application claims priority to U.S. Provisional Patent Application Ser. No. 63/660,098, entitled “DISULFIDATED POLYMERS AND METHODS OF PREPARATION,” filed Jun. 14, 2024, the disclosure of which is incorporated herein by reference in its entirety.

### BACKGROUND

High-refractive index polymers (HRIPs) play a crucial role in many optical and optoelectronic technologies, including lenses, waveguides, nanoimprinting lithography, and holography. With the increasing advances in optical devices the demand for high refractive index, high thermal stability, high transparency, and low birefringence polymers have increased exponentially. There are two ways to achieve high refractive indices polymers: (1) by introducing high refractive index inorganic nanoparticles in the polymer matrix or (2) by introducing atoms or groups with high intrinsic molar refractions.

The main strategy to develop intrinsically high refractive index polymers is the incorporation of high molar fraction groups such as sulfur, phosphorous, bromine, iodine and/or aromatic structures being sulfur one of the elements most commonly use to increase the refractive index of polymers due to its high polarizability, high stability, and straightforward insertion in the molecular structure. In recent years, various high refractive index polymers containing sulfur have been synthesized including poly (phenylene thioethers), poly(thioether sulfones), and thioether-bridge poly(phenyl quinoxalines). Unfortunately, these high refractive index sulfur containing materials require complex and elaborated synthesis, present poor processability and show low transparency which makes them unsuitable for optical applications where large-scale production and/or thick films are required.

However, despite the benefits of low shrinkage of thiolene chemistry, reduced oxygen inhibition, and delayed vitrification, its high refractive index capabilities are limited by the nature of the reaction since each ene is capable of bonding to only one sulfur in the thiolene coupling, restraining the amount of sulfur content as a mean to enhance the refractive index of polymers. In the other hand, another convenient route toward HRIPs consists of the radical-mediated addition of thiol to an alkyne, sister reaction to thiolene, but with the ability to add two thiols per alkyne unit to form 1,2-dithioether while keeping all the advantages of thiolene systems.

Even though thiolyne reactions allow a way to incorporate high amounts of sulfur atoms and increase refractive index, its chemistry have not been fully explored yet. Thus, the search for high refractive index polymers (HRIPs) with excellent transparency and facile preparation continues to be an area of highly interest. The present disclosure solves the still unmet need of preparing sulfur-containing HRIPs with desirable properties.

### BRIEF SUMMARY OF THE INVENTION

In various aspects, provided herein are methods of generating a polymer. The method includes:
contacting a compound of Formula (I):

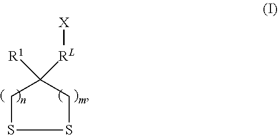

wherein
   m and n are integers and the sum of m and n is 2, 3, or 4;
   R¹ is H or C₁-C₆ alkyl;
   R^{L} is —(CH₂)ₚ—, —(OCH₂—CH₂)ₚ—, —(CHR^{L1})ₘ₁—O—(CHR^{L2}—CHR^{L3}—O)ₘ₂—(CHR^{L4})ₘ₃—C(O)—, —C(O)—(CHR^{L4})ₘ₃—(O—CHR^{L3}—CHR^{L2})ₘ₂—O—(CHR^{L1})ₘ₁—, —(CH₂)ₘ₁—Z¹—[(CH₂)ₘ₄Z²]ₘ₂—(CH₂)ₘ₃—Z³—, or —Z³—(CH₂)ₘ₃—[Z²(CH₂)ₘ₄]ₘ₂—Z¹—(CH₂)ₘ₁—;
m1, m2, and m3 are each independently an integer from 0 to 20;
m4 is an integer from 0 to 4;
p is an integer from 1 to 7;
r is an integer from 1 to 7;
R^{Z} is independently at each occurrence H or C₁-C₆ alkyl;
Z¹, Z², and Z³ are each independently absent (a bond), —O—, —S—, —NR^{L5}—, —C(O)—NR^{L5}—, or —NR^{L5}—C(O)—, wherein each R^{L5} is independently selected from the group consisting of hydrogen, C₁-C₆ alkyl, C₆-C₁₀ aryl, C₅-C₁₀ heteroaryl, C₃-C₈ cycloalkyl, and C₃-C₈ cycloheteroalkyl, each of which is optionally substituted by 1 to 3 groups selected from the group consisting of halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)₁₋₂R^{Z};
   R^{L1}, R^{L2}, R^{L3}, and R^{L4} are each independently selected from the group consisting of hydrogen, C₆-C₁₀ aryl, C₁-C₆ alkyl, C₃-C₈ cycloalkyl, C₅-C₁₀ heteroaryl, and C₃-C₈ cycloheteroalkyl, each of which are optionally substituted by 1 to 3 groups selected from the group consisting of halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, —S(O)₁₋₂R^{Z};
   X is —C(RX)₃, —OR^{X}, N(RX)₂, —S—R^{X}, —S—S—R^{X}, —CH(SR^{X})₂, —C(O)—R^{X}, —C(O)—OR^{X}, —C(O)N(R^{X})₂, —C₆₋₁₀ aryl optionally substituted by 1 to 6 R^{X} groups, —NH—C(O)—R^{X}, or —NH—C(O)—N(R^{X})₂,wherein each occurrence of R^{X} is independently selected from the group consisting of H, halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)₁₋₂R^{Z};
      with an alkyne of Formula (II):

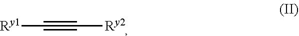

wherein
R^{y1} and R^{y2} are selected from the group consisting of hydrogen, C₆-C₁₀ aryl, C₁-C₆ alkyl, C₃-C₈ cycloalkyl, C₅-C₁₀ heteroaryl, and C₃-C₈ cycloheteroalkyl, each of which are optionally substituted by 1 to 3 groups selected from the group consisting of halogen, —CN, —C(O)—R^{Z}, —O—C(O)—R^{Z}, —(CH₂)ᵣC(O)—O—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)₁₋₂R^{Z}, provided that at least one of R^{y1} and R^{y2} is not hydrogen;
or wherein R^{y1} and R^{y2} are fused to form an 8 to 13-membered cycloalkyl ring, which is optionally substituted by 1 to 3 groups selected from the group consisting of halogen, C₆-C₁₀ aryl, C₁-C₆ alkyl, C₃-C₈ cycloalkyl, C₅-C₁₀ heteroaryl, and C₃-C₈ cycloheteroalkyl, each of which are optionally substituted by 1 to 3 groups selected from the group consisting of H, halogen, —CN, —C(O)—R^{Z}, —O—C(O)—R^{Z}, NR^{Z}R^{Z}, —NO₂, —OR^{Z}, —NR^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)₁₋₂R^{Z}.

Also provided herein are polymer compositions made from polymerizing a compound of Formula (I) with a compound of Formula (II). The polymer compositions described herein are useful in a variety of optical applications, non-limiting examples of which include lenses, waveguides, lithographs, holograms, windows, prisms, mirrors, and/or combinations thereof.

### BRIEF DESCRIPTION OF THE FIGURES

The drawings illustrate generally, by way of example, but not by way of limitation, various embodiments of the present application.

FIG. 1 shows a schematic representation of the change in refractive index from monomer to polymer in 1,2-dithiolane monomers and polymers, in accordance with various embodiments.

FIG. 2 shows chemical structures, abbreviations, names, and refractive indices for 1,2 dithiolanes and alkynes, according to various embodiments. Refractive index measurements were taken at the wavelength (k) of 589 nm using an Abbe refractometer.

FIG. 3 shows a schematic of an experimental data acquisition apparatus, including the holographic optical setup.

FIG. 4 shows holography results for LipOMe:phenylacetylene 2:1 ratio. No signal decay was observed after exposure.

FIG. 5 shows a conversion versus time plot for LipOMe and phenylacetylene as measured by Fourier Transform Infrared Spectroscopy (FT-IR) for molar ratios 4:1 (triangles), 2:1 (circles), 1:1 (squares) and 1:2 (x shapes).

FIG. 6 shows a conversion versus time plot for LipOMe and 1-octyne as measured by FT-IR for molar ratios 4:1 (triangles), 2:1 (circles), 1:1 (squares) and 1:2 (x shapes).

FIG. 7 shows a conversion versus time plot for LipOMe and propargyl acetate in a 2:1 molar ratio.

FIG. 8 shows attenuated total reflectance Fourier transform infrared (ATR-FTIR) spectra for copolymerization of 4-methyl-1,2-dithiolane-4-carboxylate (Me-AspOMe):phenyl acetylene (2:1 ratio) before and after polymerization.

FIG. 9 shows ATR-FTIR spectra for copolymerization of Me-AspOMe:phenylacetylene (2:1 ratio) before and after polymerization.

FIG. 10 shows an ¹H NMR spectrum for the crude material obtained after photopolymerization of a 2:1 mixture of Me-AspOMe:phenylacetylene, according to various embodiments.

FIG. 11 shows the chemical structure for a vinyl sulfide (dithiepine) isolated from Me-AspOMe:phenylacetylene (2:1 ratio) copolymerization reaction, according to various embodiments.

FIGS. 12A-12B show (Scheme 2 in paper), without being bound by theory, proposed mechanisms for reactions described herein, in accordance with various embodiments. FIG. 12A shows a proposed mechanism for copolymerization of alkynes and 1,2-dithiolanes via propagation of thiyl radical across triple bond and subsequent radical addition to new dithiolane.

FIG. 12B shows a proposed mechanism for the formation of isolated cyclic vinyl sulfide via intramolecular radical disulfide scission.

FIGS. 13A-13D show aspects of recorded holograms. FIG. 13A shows recorded holograms for a two-stage photopolymer sample of LipOMe and yne attachment (between glass slides with 30 m spacers from a Bragg-matched viewing angle). FIG. 13B shows a Bragg-angle playback curve of a representative hologram showing excellent agreement with Kogelnik's coupled-wave theory (CWT) for volume-phase transmission holograms. FIG. 13C shows a growth development curve of diffraction efficiency during exposure, monitored nondestructively at the Bragg condition of the grating. FIG. 13D shows recorded holograms after 1 year of storage at room temperature.

FIG. 14 shows FT-IR spectra for 2:1 Me-AspOMe:phenylacetylene before and after polymerization.

FIG. 15 shows molecular structures and abbreviations of components of the matrix used for holography films, according to various embodiments.

FIG. 16 shows real-time measurement of conversion as a function of time for LipOMe (black squares) and Me-AspOMe (red circles) showing that LipOMe reacts 12 times faster than Me-AspOMe upon exposure filtered 450±50 nm light at an intensity of 40 mW cm⁻² (1 wt % TPO photoinitiator). The dotted line indicates when the light was turned on at 30 seconds. Delayed polymerization was observed for Me-AspOMe.

FIGS. 17A-17D show conversion vs. time plots for alkyne reactive groups (λ=405 nm, I=40 mW cm⁻², t=600 s). FIG. 17A shows data for LipOMe:phenylacetylene. FIG. 17B shows data for LipOMe:1-octyne. FIG. 17C shows data for LipOMe:propargyl acetate. FIG. 17D shows data for LipOMe:diphenylacetylene. Black squares (dithiolane:yne=1:1), red circles (dithiolane:yne=1:2), blue triangles (dithiolane:yne=2:1), green upside-down triangles (dithiolane:yne=4:1).

FIGS. 18A-18B show FTIR spectra (region between 800-500 cm⁻¹) for LipOMe (FIG. 18A) and Me-AspOMe (FIG. 18B) before and after polymerization. In each spectrum the polymer is the upper trace.

FIGS. 19A-19B show FTIR spectra region between 800-500 cm⁻¹ for LipOMe (FIG. 19A) and Me-AspOMe (FIG. 19B) before, after polymerization, and after heating 140° C. for 3 h.

FIG. 20 shows FTIR conversion versus time plots for alkyne reactive groups. a) Me-AspOMe:phenylacetylene, for molar ratios dithiolane:yne=1:1 (black squares), dithiolane:yne=1:2 (red circle), dithiolane:yne=2:1 (blue triangles), dithiolane:yne=4:1 (green triangles). Photopolymerization conditions: 405-500 nm filtered light, 40 mW/cm², 600s.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

### Definitions

The term “about” as used herein can allow for a degree of variability in a value or range, for example, within 10%, within 5%, or within 1% of a stated value or of a stated limit of a range, and includes the exact stated value or range.

The term “amine” as used herein refers to primary, secondary, and tertiary amines having, e.g., the formula N(group)₃ wherein each group can independently be H or non-H, such as alkyl, aryl, and the like. Amines include but are not limited to R—NH₂, for example, alkylamines, arylamines, alkylarylamines; R₂NH wherein each R is independently selected, such as dialkylamines, diarylamines, aralkylamines, heterocyclylamines and the like; and R₃N wherein each R is independently selected, such as trialkylamines, dialkylarylamines, alkyldiarylamines, triarylamines, and the like. The term “amine” also includes ammonium ions as used herein.

The term “amino group” as used herein refers to a substituent of the form —NH₂, —NHR, —NR₂, —NR, wherein each R is independently selected, and protonated forms of each, except for —NR₃+, which cannot be protonated. Accordingly, any compound substituted with an amino group can be viewed as an amine. An “amino group” within the meaning herein can be a primary, secondary, tertiary, or quaternary amino group. An “alkylamino” group includes a monoalkylamino, dialkylamino, and trialkylamino group.

The term “acyl” as used herein refers to a group containing a carbonyl moiety wherein the group is bonded via the carbonyl carbon atom. The carbonyl carbon atom is bonded to a hydrogen forming a “formyl” group or is bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. An acyl group can include 0 to about 12, 0 to about 20, or 0 to about 40 additional carbon atoms bonded to the carbonyl group. An acyl group can include double or triple bonds within the meaning herein. An acryloyl group is an example of an acyl group. An acyl group can also include heteroatoms within the meaning herein. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some embodiments, from 2 to 8 carbon atoms. Examples include, but are not limited to vinyl, —CH═C═CCH₂, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include about 1 to about 12, about 1 to about 20, or about 1 to about 40 carbon atoms bonded to the oxygen atom, and can further include double or triple bonds, and can also include heteroatoms. For example, an allyloxy group or a methoxyethoxy group is also an alkoxy group within the meaning herein, as is a methylenedioxy group in a context where two adjacent atoms of a structure are substituted therewith.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkynyl” as used herein refers to straight and branched chain alkyl groups, except that at least one triple bond exists between two carbon atoms. Thus, alkynyl groups have from 2 to 40 carbon atoms, 2 to about 20 carbon atoms, or from 2 to 12 carbons or, in some embodiments, from 2 to 8 carbon atoms. Examples include, but are not limited to —C—CH, —C—C(CH₃), —C≡C(CH₂CH₃), —CH₂C≡CH, —CH₂C≡C(CH₃), and —CH₂C≡C(CH₂CH₃) among others.

The term “aralkyl” as used herein refers to alkyl groups as defined herein in which a hydrogen or carbon bond of an alkyl group is replaced with a bond to an aryl group as defined herein. Representative aralkyl groups include benzyl and phenylethyl groups and fused (cycloalkylaryl)alkyl groups such as 4-ethyl-indanyl. Aralkenyl groups are alkenyl groups as defined herein in which a hydrogen or carbon bond of an alkyl group is replaced with a bond to an aryl group as defined herein.

The term “aryl” as used herein refers to cyclic aromatic hydrocarbon groups that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

As used herein, the term “copolymer” refers to a polymer formed from two or more different repeating units (monomers). By way of example and without limitation, a copolymer can be an alternating copolymer, a random copolymer, a block copolymer, or a graft copolymer.

It is also contemplated that, in certain aspects, various block segments of a block copolymer can themselves comprise copolymers.

As used herein, the term “composition” refers to a mixture of at least one compound described herein. The composition may be comprised of a polymer or polymer mixture. The composition may be formed into a device, shape, or form for a particular application.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined herein. Representative substituted cycloalkyl groups can be mono-substituted or substituted more than once, such as, but not limited to, 2,2-, 2,3-, 2,4-2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

The terms “halo,” “halogen,” or “halide” group, as used herein, by themselves or as part of another substituent, mean, unless otherwise stated, a fluorine, chlorine, bromine, or iodine atom.

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “heteroaryl” as used herein refers to aromatic ring compounds containing 5 or more ring members, of which, one or more is a heteroatom such as, but not limited to, N, O, and S; for instance, heteroaryl rings can have 5 to about 8-12 ring members. A heteroaryl group is a variety of a heterocyclyl group that possesses an aromatic electronic structure. A heteroaryl group designated as a C₂-heteroaryl can be a 5-ring with two carbon atoms and three heteroatoms, a 6-ring with two carbon atoms and four heteroatoms and so forth. Likewise a C₄-heteroaryl can be a 5-ring with one heteroatom, a 6-ring with two heteroatoms, and so forth. The number of carbon atoms plus the number of heteroatoms sums up to equal the total number of ring atoms. Heteroaryl groups include, but are not limited to, groups such as pyrrolyl, pyrazolyl, triazolyl, tetrazolyl, oxazolyl, isoxazolyl, thiazolyl, pyridinyl, thiophenyl, benzothiophenyl, benzofuranyl, indolyl, azaindolyl, indazolyl, benzimidazolyl, azabenzimidazolyl, benzoxazolyl, benzothiazolyl, benzothiadiazolyl, imidazopyridinyl, isoxazolopyridinyl, thianaphthalenyl, purinyl, xanthinyl, adeninyl, guaninyl, quinolinyl, isoquinolinyl, tetrahydroquinolinyl, quinoxalinyl, and quinazolinyl groups. Heteroaryl groups can be unsubstituted, or can be substituted with groups as is discussed herein. Representative substituted heteroaryl groups can be substituted one or more times with groups such as those listed herein.

Additional examples of aryl and heteroaryl groups include but are not limited to phenyl, biphenyl, indenyl, naphthyl (1-naphthyl, 2-naphthyl), N-hydroxytetrazolyl, N-hydroxytriazolyl, N-hydroxyimidazolyl, anthracenyl (1-anthracenyl, 2-anthracenyl, 3-anthracenyl), thiophenyl (2-thienyl, 3-thienyl), furyl (2-furyl, 3-furyl), indolyl, oxadiazolyl, isoxazolyl, quinazolinyl, fluorenyl, xanthenyl, isoindanyl, benzhydryl, acridinyl, thiazolyl, pyrrolyl (2-pyrrolyl), pyrazolyl (3-pyrazolyl), imidazolyl (1-imidazolyl, 2-imidazolyl, 4-imidazolyl, 5-imidazolyl), triazolyl (1,2,3-triazol-1-yl, 1,2,3-triazol-2-yl 1,2,3-triazol-4-yl, 1,2,4-triazol-3-yl), oxazolyl (2-oxazolyl, 4-oxazolyl, 5-oxazolyl), thiazolyl (2-thiazolyl, 4-thiazolyl, 5-thiazolyl), pyridyl (2-pyridyl, 3-pyridyl, 4-pyridyl), pyrimidinyl (2-pyrimidinyl, 4-pyrimidinyl, 5-pyrimidinyl, 6-pyrimidinyl), pyrazinyl, pyridazinyl (3-pyridazinyl, 4-pyridazinyl, 5-pyridazinyl), quinolyl (2-quinolyl, 3-quinolyl, 4-quinolyl, 5-quinolyl, 6-quinolyl, 7-quinolyl, 8-quinolyl), isoquinolyl (1-isoquinolyl, 3-isoquinolyl, 4-isoquinolyl, 5-isoquinolyl, 6-isoquinolyl, 7-isoquinolyl, 8-isoquinolyl), benzo[b]furanyl (2-benzo[b]furanyl, 3-benzo[b]furanyl, 4-benzo[b]furanyl, 5-benzo[b]furanyl, 6-benzo[b]furanyl, 7-benzo[b]furanyl), 2,3-dihydro-benzo[b]furanyl (2-(2,3-dihydro-benzo[b]furanyl), 3-(2,3-dihydro-benzo[b]furanyl), 4-(2,3-dihydro-benzo[b]furanyl), 5-(2,3-dihydro-benzo[b]furanyl), 6-(2,3-dihydro-benzo[b]furanyl), 7-(2,3-dihydro-benzo[b]furanyl), benzo[b]thiophenyl (2-benzo[b]thiophenyl, 3-benzo[b]thiophenyl, 4-benzo[b]thiophenyl, 5-benzo[b]thiophenyl, 6-benzo[b]thiophenyl, 7-benzo[b]thiophenyl), 2,3-dihydro-benzo[b]thiophenyl, (2-(2,3-dihydro-benzo[b]thiophenyl), 3-(2,3-dihydro-benzo[b]thiophenyl), 4-(2,3-dihydro-benzo[b]thiophenyl), 5-(2,3-dihydro-benzo[b]thiophenyl), 6-(2,3-dihydro-benzo[b]thiophenyl), 7-(2,3-dihydro-benzo[b]thiophenyl), indolyl (1-indolyl, 2-indolyl, 3-indolyl, 4-indolyl, 5-indolyl, 6-indolyl, 7-indolyl), indazole (1-indazolyl, 3-indazolyl, 4-indazolyl, 5-indazolyl, 6-indazolyl, 7-indazolyl), benzimidazolyl (1-benzimidazolyl, 2-benzimidazolyl, 4-benzimidazolyl, 5-benzimidazolyl, 6-benzimidazolyl, 7-benzimidazolyl, 8-benzimidazolyl), benzoxazolyl (1-benzoxazolyl, 2-benzoxazolyl), benzothiazolyl (1-benzothiazolyl, 2-benzothiazolyl, 4-benzothiazolyl, 5-benzothiazolyl, 6-benzothiazolyl, 7-benzothiazolyl), carbazolyl (1-carbazolyl, 2-carbazolyl, 3-carbazolyl, 4-carbazolyl), 5H-dibenz[b,f]azepine (5H-dibenz[b,f]azepin-1-yl, 5H-dibenz[b,f]azepine-2-yl, 5H-dibenz[b,f]azepine-3-yl, 5H-dibenz[b,f]azepine-4-yl, 5H-dibenz[b,f]azepine-5-yl), 10,11-dihydro-5H-dibenz[b,f]azepine (10,11-dihydro-5H-dibenz[b,f]azepine-1-yl, 10,11-dihydro-5H-dibenz[b,f]azepine-2-yl, 10,11-dihydro-5H-dibenz[b,f]azepine-3-yl, 10,11-dihydro-5H-dibenz[b,f]azepine-4-yl, 10,11-dihydro-5H-dibenz[b,f]azepine-5-yl), and the like.

The term “heteroarylalkyl” as used herein refers to alkyl groups as defined herein in which a hydrogen or carbon bond of an alkyl group is replaced with a bond to a heteroaryl group as defined herein.

The term “heterocyclylalkyl” as used herein refers to alkyl groups as defined herein in which a hydrogen or carbon bond of an alkyl group as defined herein is replaced with a bond to a heterocyclyl group as defined herein. Representative heterocyclyl alkyl groups include, but are not limited to, furan-2-yl methyl, furan-3-yl methyl, pyridine-3-yl methyl, tetrahydrofuran-2-yl ethyl, and indol-2-yl propyl.

The term “heterocyclyl” as used herein refers to aromatic and non-aromatic ring compounds containing three or more ring members, of which one or more is a heteroatom such as, but not limited to, N, O, and S. Thus, a heterocyclyl can be a cycloheteroalkyl, or a heteroaryl, or if polycyclic, any combination thereof. In some embodiments, heterocyclyl groups include 3 to about 20 ring members, whereas other such groups have 3 to about 15 ring members. A heterocyclyl group designated as a C₂-heterocyclyl can be a 5-ring with two carbon atoms and three heteroatoms, a 6-ring with two carbon atoms and four heteroatoms and so forth.

Likewise a C₄-heterocyclyl can be a 5-ring with one heteroatom, a 6-ring with two heteroatoms, and so forth. The number of carbon atoms plus the number of heteroatoms equals the total number of ring atoms. A heterocyclyl ring can also include one or more double bonds. A heteroaryl ring is an embodiment of a heterocyclyl group. The phrase “heterocyclyl group” includes fused ring species including those that include fused aromatic and non-aromatic groups.

For example, a dioxolanyl ring and a benzdioxolanyl ring system (methylenedioxyphenyl ring system) are both heterocyclyl groups within the meaning herein. The phrase also includes polycyclic ring systems containing a heteroatom such as, but not limited to, quinuclidyl. Heterocyclyl groups can be unsubstituted, or can be substituted as discussed herein. Heterocyclyl groups include, but are not limited to, pyrrolidinyl, piperidinyl, piperazinyl, morpholinyl, pyrrolyl, pyrazolyl, triazolyl, tetrazolyl, oxazolyl, isoxazolyl, thiazolyl, pyridinyl, thiophenyl, benzothiophenyl, benzofuranyl, dihydrobenzofuranyl, indolyl, dihydroindolyl, azaindolyl, indazolyl, benzimidazolyl, azabenzimidazolyl, benzoxazolyl, benzothiazolyl, benzothiadiazolyl, imidazopyridinyl, isoxazolopyridinyl, thianaphthalenyl, purinyl, xanthinyl, adeninyl, guaninyl, quinolinyl, isoquinolinyl, tetrahydroquinolinyl, quinoxalinyl, and quinazolinyl groups. Representative substituted heterocyclyl groups can be mono-substituted or substituted more than once, such as, but not limited to, piperidinyl or quinolinyl groups, which are 2-, 3-, 4-, 5-, or 6-substituted, or disubstituted with groups such as those listed herein.

The term “hydrocarbon” or “hydrocarbyl” as used herein refers to a molecule or functional group that includes carbon and hydrogen atoms. The term can also refer to a molecule or functional group that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b})hydrocarbyl, wherein a and b are integers and mean having any of a to b number of carbon atoms. For example, (C₁-C₄)hydrocarbyl means the hydrocarbyl group can be methyl (C₁), ethyl (C₂), propyl (C₃), or butyl (C₄), and (C₀-C_{b})hydrocarbyl means in certain embodiments there is no hydrocarbyl group.

The term “independently selected from” as used herein refers to referenced groups being the same, different, or a mixture thereof, unless the context clearly indicates otherwise. Thus, under this definition, the phrase “X¹, X², and X³ are independently selected from noble gases” would include the scenario where, for example, X¹, X², and X³ are all the same, where X¹, X², and X³ are all different, where X¹ and X² are the same but X³ is different, and other analogous permutations.

The term “molecular weight” as used herein may refer to mass average molecular weight or number average molecular weight.

The term “monovalent” as used herein refers to a substituent connecting via a single bond to a substituted molecule. When a substituent is monovalent, such as, for example, F or C₁, it is bonded to the atom it is substituting by a single bond.

The term “optical tool” refers to a material or composition that is useful in applications related to manipulation of light transmittal. Optical tools may help enhance an image, analyze a material, or perform similar related functions.

The term “organic group” as used herein refers to any carbon-containing functional group. Examples can include an oxygen-containing group such as an alkoxy group, aryloxy group, aralkyloxy group, oxo(carbonyl) group; a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R can be hydrogen (in examples that include other carbon atoms) or a carbon-based moiety, and wherein the carbon-based moiety can be substituted or unsubstituted.

The term “polymer” refers a composition comprising at least two subunits of a monomer substructure, and can be represented by a repeated monomer unit. References to a “polymer” include a single polymer as well as two or more of the same or different polymers. Polymers may be any class of natural or synthetic substance that are multiples of simpler chemical units called monomers.

The term “refractive index” (R.I., also nD) refers to a dimensionless number that gives an indication of the light bending ability of a medium, material, or composition based on the ratio of the speed of light in a vacuum and the speed of light in a given medium, material, or composition. The refractive index is also equal to the velocity of light c of a given wavelength in empty space divided by its velocity v in a substance in a substance. Refractive index also indicates how much the direction of light changes as it passes through a medium.

The term “room temperature” as used herein refers to a temperature of about 15° C. to 28° C.

The term “solvent” as used herein refers to a liquid that can dissolve a solid, liquid, or gas. Non-limiting examples of solvents are silicones, organic compounds, water, alcohols, ionic liquids, and supercritical fluids.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that the composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less. The term “substantially free of” can mean having a trivial amount of, such that a composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

### Development and Implementation of an FTIR-Based Technique for the Homopolymerization Kinetics of LipOMe and Me-AspOMe

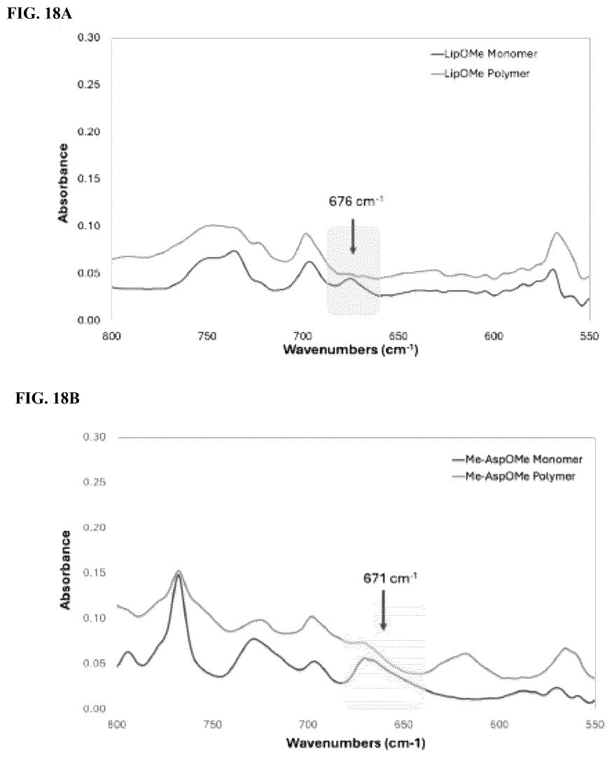

The methyl ester of lipoic acid (LipOMe) and methyl 4-methyl-1,2-dithiolane-4-carboxylate (Me-AspOMe) were synthesized as described herein. Homopolymers of the methyl ester of lipoic acid (LipOMe) and methyl 4-methyl-1,2-dithiolane-4-carboxylate (Me-AspOMe) were obtained via dithiolane ring opening photopolymerization by irradiating in bulk the low viscosity monomers containing 1 wt % TPO as the photoinitiator with 400-500 nm filtered mercury arc lamp at 40 mW cm⁻² for 600 s, as described herein in various embodiments. FTIR was demonstrated to be suitable for monitoring the homopolymerization kinetics of the dithiolane unit of these two monomers. FIGS. 18A and 18B show the FTIR spectra region between 800 and 500 cm⁻¹ for LipOMe and Me-AspOMe before and after polymerization obtained by attenuated total reflectance Fourier transform infrared spectroscopy (ATR-FTIR) spectroscopy. The corresponding before and after polymerization spectra of the in situ polymerization were collected using 64 scans and 4 cm⁻¹ resolution.

High degrees of conversion, 92% (LipOMe) and 75% (Me-AspOMe) were determined by measuring the intensity of the peak area corresponding to C—S stretching at 676 cm⁻¹ for LipOMe and 671 cm⁻¹ for Me-AspOMe before and after polymerization. The FTIR technique and the corresponding conversions for the two 1,2-dithiolanes under study were validated by ¹H NMR (32 scans, d1=10 s) by comparing the integrals of the polymer peak and monomer peak using the signals for the CH₂ hydrogen in the dithiolane ring. For LipOMe, the peak used for conversion calculations for the unreacted monomer was found at 2.50 ppm, and for the polymer at 2.80 ppm, while for the Me-AspOMe monomer, the peak chosen was at 3.70 ppm (or 2.97 ppm) for the monomer and at 3.17 ppm for the polymer. Table S1 summarizes, among other properties, conversion results obtained for ATR-FTIR and ¹H NMR, showing agreement between the two techniques and verifying that the FTIR technique is suitable to monitor the ring-opening of the 1,2-dithiolane during homopolymerizations.

TABLE S1
Conversion for LipOMe and Me-AspOMe was obtained from
FTIR and ¹H NMR, and the percentage of monomers recovered
after heating at 140° C. for 3 hours. GPC for
poly(LipOMe) and poly(Me-AspOMe). Refractive indices for the
dithiolanes monomers and their homopolymers and Δn values.
Samples were polymerized in bulk, 40 Mw/cm² light,
filtered 400-500 nm for 600 s.

| Property | LipOMe | Me-AspOMe |
|---|---|---|
| Conversion | 92 ± 2% | 75 ± 2% |
| (ATR FT-IR) | | |
| Conversion | 87 ± 3% | 75 ± 3% |
| (¹H NMR) | | |
| % Monomer recovered | 84% | 10% |
| after heating | | |
| Mn (KDa) | 14.7 | 12.0 |
| Mw (KDa) | 17.8 | 14.7 |
| Ð | 1.21 | 1.23 |
| n_{D} (589 nm, 20° C.) | 1.512 | 1.523 |
| Monomer | | |
| n_{D} (589 nm, 20° C.) | 1.530 | 1.566 |
| Polymer | | |
| Δn | 0.02 | 0.04 |

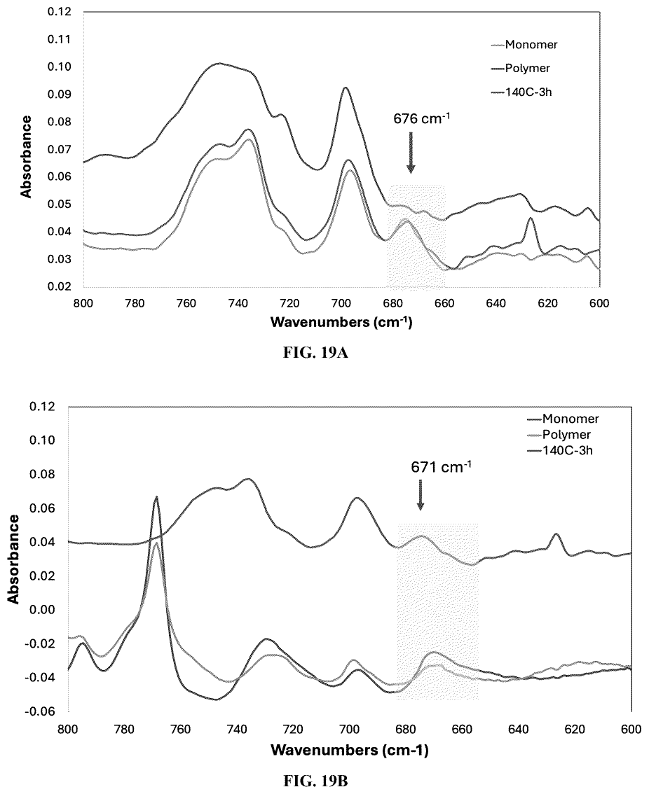

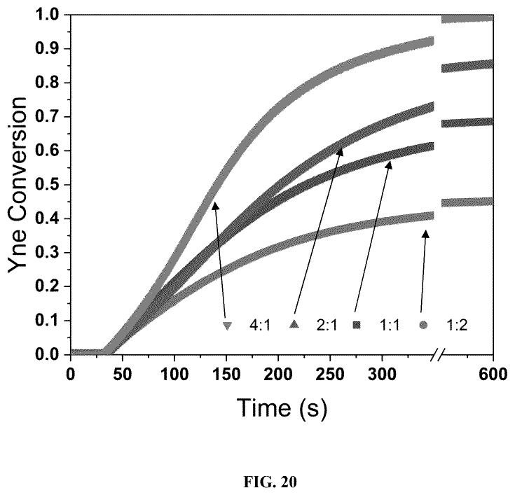

The reversible nature of the ring-opening polymerization reaction for LipOMe and Me-AspOMe was studied by ATR-FTIR, monitoring the recovery of the monomer peaks at 676 cm⁻¹ and 671 cm⁻¹ for LipOMe and Me-AspOMe after heating the polymer samples at 140° C. for 3 hours (FIGS. 19A-19B). The percentages of LipOMe and Me-AspOMe recovered after heating the respective polymers under the same conditions were 84% for LipOMe and 10% for Me-AspOMe evidencing the more stable nature of poly(Me-AspOMe) toward depolymerization, compared to poly(LipOMe). It may seem counterintuitive that the monomer that exhibits lower reaction rates would also yield lower recovery upon depolymerization. It must be noted that it cannot be assumed that equilibrium, as governed by the thermodynamics of the system, will correlate with kinetic reaction rates.

Alternative experimental conditions may prove more or less favorable to the asparagusate monomer recovery. Table S2 summarizes the conversion values obtained from peak area values for the initial monomers, the polymer following photopolymerization, and the sample after heating using the equation:

$$\% m 2 = \frac{{A}_{m 2} - {A}_{p}}{{A}_{m 2} - {A}_{p}} \cdot 100$$

where Aₘ₁ is the area peak for the monomer initially, Aₘ₂ is the area after heating the polymer, and Aₚ is the peak area of the remaining monomer after polymerization before the sample is heated; in other words, the peak area for the unreacted monomer upon polymerization.

TABLE S2
Values of area peak obtained by FT-IR for LipOMe and Me-
AspOMe before, after polymerization, and after heating
the polymers. Percentages of conversion and monomer recovered.
Photopolymerization reactions were initiated with 40
mW/cm² light, filtered at 400-500 nm. Samples were photoactivated
with 1 wt % TPO photoinitiator.

| | | | | Area of | % |
|---|---|---|---|---|---|
| | Initial | Final | | Monomer | Monomer |
| Compound | Area | Area | Conversion | Recovered | Recovered |
| LipOMe | 0.1226 | 0.0126 | 90% | 0.1054 | 84% |
| Me-AspOMe | 0.0650 | 0.0160 | 75% | 0.0210 | 10% |

Time-dependent photopolymerization reaction kinetics were also measured by FTIR spectroscopy during the photopolymerization. The polymerization rate was calculated from the rate at which the monomer is being consumed using the equation Rₚ=−d[M]/dt, where Rₚ is the rate of polymerization, [M] concentration of monomer at any given time, and d[M]/dt is the rate of decrease in monomer concentration with respect to time. Polymerization delay was observed for Me-AspOMe but not for LipOMe (FIG. 16), demonstrating a difference in reactivity for the 1,2-dithiolanes. As expected, LipOMe reacted 12 times faster (Rₚ=0.05 s⁻¹) than Me-AspOMe (Rₚ=0.006 s⁻¹).

This data correlates with ring substitution patterns being determined to be an important factor in the reactivity of 1,2-dithiolanes due to ring strain, which was found to be more significant for LipOMe than Me-AspOMe. Earlier, Whiteside and coworkers showed that higher-substituted 1,2-dithiolanes are more resistant to reduction and ring opening. A modular gel permeation chromatography (GPC/SEC) system equipped with a refractive index detector was employed to determine the weight average molecular weight (M_{w}), number average molecular weight (Mₙ), and dispersity Ð=M_{w}/Mₙ of the photopolymer obtained based on polystyrene standards. LipOMe and Me-AspOMe homopolymers show molecular weights of 14 kDa and 12 kDa with a relatively narrow dispersity of Ð=1.21 and 1.23, respectively (Table S1). Both polymers were soluble in commonly used organic solvents. The index of refraction of the synthesized monomers and their polymers was measured at 20° C. using an Abbe refractometer (589 nm).

Table S1 shows that the ring-opening polymerization of the 1,2-dithiolanes increases the refractive index by 0.02 for LipOMe and 0.04 for Me-AspOMe. The high refractive index values of the polymers obtained are a direct result of the high inherent atomic refraction of the sulfur-containing polymers. The higher Δn value for Me-AspOMe is not a surprise as the refractive index is predicted by the Lorentz-Lorenz equation:

$$\frac{{n}^{2} - 1}{{n}^{2} + 1} = \frac{R}{M} \cdot \frac{M}{V} = \frac{{R}_{m}}{{V}_{m}} ,$$

where R is the molecular refraction, M the molecular weight and V the molecular volume of the repeat unit. R/M can also be represented as molar refraction (Rm) and M/V as the reciprocal of the molar volume (Vₘ). Accordingly, a substituent (repetitive unit) with a high molar fraction and a low molar volume like Me-AspOMe will increase the refractive index (nD) of the polymer Scheme 1b.

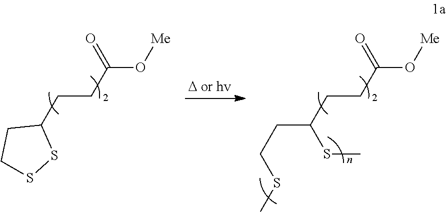

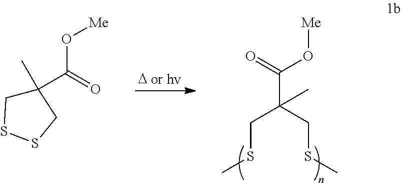

Scheme 1a and 1b: Thermal or light-activated homopolymerization of the dithiolanes (a) LipOMe and (b) Me-AspOMe.
Copolymerization of LipOMe with Alkynes

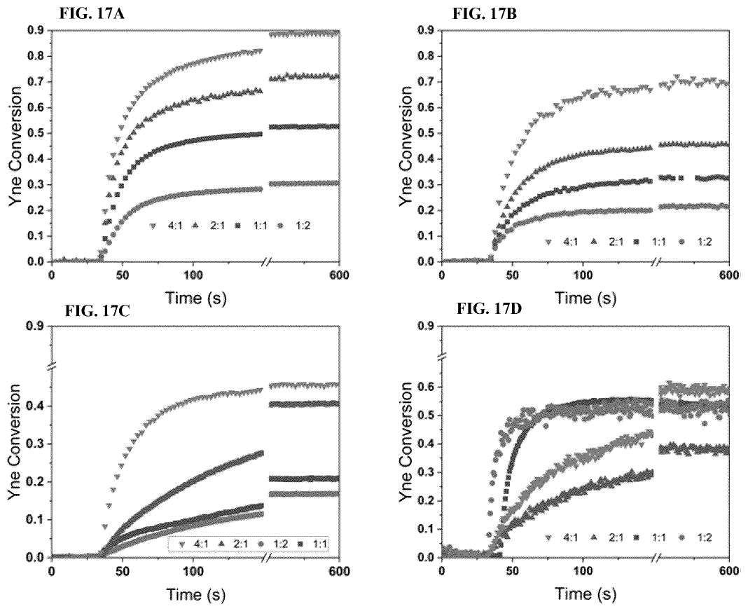

The consumption of the alkynes as a function of time during photopolymerization with 20 LipOMe at various stoichiometric ratios was monitored using Fourier Transform Infrared (FTIR) spectroscopy with the horizontal device accessory previously described. The peaks corresponding to the C—C—H stretching absorption, at 3301, 3313, and 3294 cm⁻¹ for phenylacetylene, 1-octyne, and propargyl acetate, were selected to track the consumption of alkynes during polymerization (FIGS. 17A-17D). In the absence of C—C—H stretching for diphenylacetylene, the most prominent band of the alkynes in the IR spectrum centered at 2219 cm⁻¹, which is associated with C≡C, was used for the internal alkyne. Even though the C≡C stretching (˜2200 cm⁻¹) appears as a weak band, the resultant noise was not problematic as the standard deviations were consistent with other trials (FIG. 17D).

Unfortunately, the ring-opening reaction of the 1,2-dithiolane ring could not be monitored simultaneously because the corresponding peak areas for C—S overlap with the absorption peaks of components in the reaction mixtures; however, they were confirmed by ¹H NMR on the same samples analyzed by FTIR. The corresponding conversions reached for the LipOMe during copolymerization with alkynes relate to the reaction with the alkynes as well as homopolymerization (Table 2). FIGS. 17A-17D and Table 2 display conversion versus time for the different compositions and ratios, final alkyne conversion (by FTIR), calculated reaction rates, and dithiolane conversion obtained from the ¹H NMR. The rapid consumption of alkynes occurs in the first seconds of the reaction.

Moreover, a higher degree of alkyne conversions is observed at higher LipOMe concentrations (dithiolane:yne=4:1>2:1>1:1>1:2) for all the terminal alkynes. It is essential to mention that, for the same stoichiometric ratios, the order of reaction rates observed for the different terminal alkynes studied here follows the trend of phenylacetylene>1-octyne>propargyl acetate (Table 2). Without being bound by theory, the slow addition rate of LipOMe to propargyl acetate is rationalized in terms of electron density, like in the case of thiol-ene reactions, where photoaddition of thiols to electron-poor vinyl groups is unfavorable. Here, the thiyl radicals known for their electrophilic character react slowly with propargyl acetate as the electron-withdrawing carbonyl decreases the electron density of the π bonds. This effect was also observed for the photoinitiated addition of thiols to propargyl acetate and methyl propargyl ether. It is important to mention that while no homopolymerization of alkynes was observed in the absence of dithiolane, higher than anticipated alkyne consumption, presumably due to chain addition reactions between alkynes and unsaturated carbon-carbon bonds (i.e. alkynes, vinyl sulfides), was observed at low relative ratios of dithiolane, as monitored by FTIR and ¹H NMR (Table 2). Similar behavior was reported in thiol limited thiol-yne addition reactions.

The results obtained for the internal alkyne were unexpected in that at higher concentrations of diphenylacetylene 1:1 and 1:2 (dithiolane:yne) ratios (FIG. 17D), the final yne consumption reached values of 53% and 52%, respectively, which is similar to that found for the 4:1 ratio of dithiolane:yne (56%). Furthermore, the cure rates obtained exceed that of formulations with lower ratios of diphenylacetylene and even the ones of terminal alkynes. A more careful inspection of the KBr windows for the formulations before and after polymerization showed the presence of an opaque waxy solid for the higher concentrations of diphenylacetylene. The observed results may suggest a level of ordering or templating in the crystalline state, significantly enhancing the propagation reaction while minimizing termination.

The copolymerization of LipOMe with terminal alkynes studied resulted in the emergence of a new peak at 1545 cm⁻¹ in the FT-IR spectrum and an approximate chemical shift of 6.0 ppm in the ¹H NMR spectrum. This observation indicates the formation of a vinyl sulfide intermediate, similar to the one observed in the case of thiol-yne photopolymerization. 32 However, the shift to higher frequencies for LipOMe-yne, compared to thiol-yne—which typically shows peaks in the FT-IR spectrum between 1620 and 1600 cm⁻¹—suggests that the vinyl sulfide intermediate found during this research has a distinct structure. A more detailed discussion on the formation of the vinyl sulfide intermediate will follow in the next section. GPC results of the polymerized comonomer mixtures are presented in Table S3. Interestingly, the polymers obtained through this route are characterized by narrow dispersity Ð<1.4. The index of refraction for 1,2-dithiolane and alkyne mixtures before and after polymerization are summarized in Table S3. It is important to mention that a portion of 1,2-dithiolane monomer and its homopolymers are left in the mix after polymerization, so it is expected that the refractive index R.I. here showed are lower than expected due to incomplete polymerization and homopolymers formed.

TABLE S3
Formulation composition for LipOMe and ynes, monomer ratios, polymer number
average molecular weight (Mn), dispersity (Ð), indices of refraction for
unreacted monomer formulations and the resulting copolymers, and the difference
between those indices. Mn and Ð obtained via GPC. Refractive index measurements
were taken at the wavelength (λ) of 589 nm using an Abbe refractometer.

| | | Mn | | n_{D} | n_{D} | |
|---|---|---|---|---|---|---|
| Composition | Ratio | (kDa) | Ð | Unreacted | Polymer | Δn |
| LipOMe:phenylacetylene | 4:1 | 16.4 | 1.28 | 1.508 | 1.559 | 0.05 |
| LipOMe:phenylacetylene | 2:1 | 18.7 | 1.33 | 1.506 | 1.547 | 0.04 |
| LipOMe:phenylacetylene | 1:1 | 20.0 | 1.40 | 1.505 | 1.545 | 0.04 |
| LipOMe:phenylacetylene | 1:2 | 15.3 | 1.30 | 1.502 | 1.519 | 0.02 |
| LipOMe:1-octyne | 4:1 | 10.5 | 1.29 | 1.517 | 1.528 | 0.01 |
| LipOMe:1-octyne | 2:1 | 15.3 | 1.23 | 1.501 | 1.517 | 0.01 |
| LipOMe:1-octyne | 1:1 | 11.2 | 1.27 | 1.491 | 1.505 | 0.01 |
| LipOMe:1-octyne | 1:2 | 10.5 | 1.27 | 1.466 | 1.477 | 0.01 |
| LipOMe:propargyl acetate | 4:1 | 16.7 | 1.28 | 1.495 | 1.511 | 0.02 |
| LipOMe:propargyl acetate | 2:1 | 19.6 | 1.29 | 1.506 | 1.534 | 0.02 |
| LipOMe:propargyl acetate | 1:1 | 16.8 | 1.39 | 1.515 | 1.542 | 0.03 |
| LipOMe:propargyl acetate | 1:2 | 14.1 | 1.31 | 1.508 | 1.540 | 0.03 |
| LipOMe:diphenylacetylene | 4:1 | 7.5 | 1.44 | 1.530 | 1.600 | 0.07 |
| LipOMe:diphenylacetylene | 2:1 | 10.6 | 1.48 | 1.514 | 1.584 | 0.07 |
| LipOMe:diphenylacetylene | 1:1 | 8.1 | 1.52 | 1.596* | / | / |
| LipOMe:diphenylacetylene | 1:2 | 6.3 | 1.65 | 1.612* | / | / |

*Waxy/Crystalline Material

Copolymerization of Me-AspOMe with Alkynes

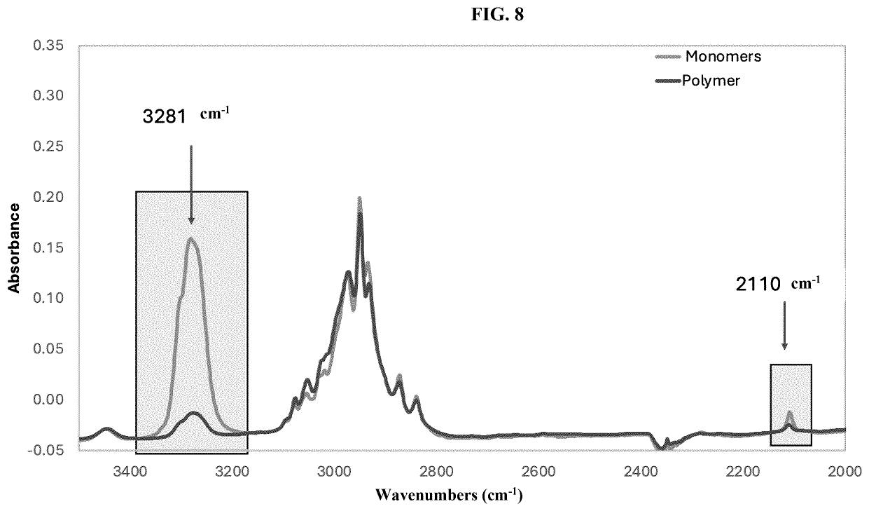

Polymerization reactions of Me-AspOMe with alkynes were also studied using FTIR using the horizontal attachment. Similar to LipOMe, the FTIR spectra for the photopolymerization reactions of Me-AspOMe with alkynes showed, as expected, a decrease of the peaks at ˜3281 and ˜2110 cm⁻¹ corresponding to —C—H and C≡C stretching upon polymerization (FIG. 8). Also, as expected, the appearance of the vinyl sulfide peak at 1530 cm⁻¹ (FIG. 9) was observed at an even higher frequency than the one observed for the vinyl sulfide derivate of LipOMe (which was located around 1545 cm⁻¹). The photopolymerization of Me-AspOMe with alkynes highlighted differences in the reactivity between the two dithiolanes studied FIG. 20 and Table S4). The final conversion reached for the two dithiolanes resulted in values within the same order of magnitude.

TABLE S4
Formulation composition for Me-AspOMe and alkynes, monomer ratios,
polymer number average molecular weight (Mn), dispersity (Ð),
indices of refraction for unreacted monomer formulations and the
resulting copolymers, and the difference between those indices. Mn
and Ð obtained by GPC. Refractive index measurements were taken
at the wavelength (λ) of 589 nm using an Abbe refractometer.

| | | Mn | | n_{D} | n_{D} | |
|---|---|---|---|---|---|---|
| Composition | Ratio | (KDa) | Ð | Unreacted | Polymer | Δn |
| Me-AspOMe:phenylacetylene | 4:1 | 9.9 | 1.32 | 1.528 | 1.583 | 0.06 |
| Me-AspOMe:phenylacetylene | 2:1 | 13.0 | 1.43 | 1.532 | 1.588 | 0.06 |
| Me-AspOMe:phenylacetylene | 1:1 | 9.0 | 1.23 | 1.502 | 1.560 | 0.06 |
| Me-AspOMe:phenylacetylene | 1:2 | 9.0 | 1.19 | 1.506 | 1.557 | 0.05 |
| Me-AspOMe:1-octyne | 2:1 | 8.0 | 1.15 | 1.500 | 1.513 | 0.01 |
| Me-AspOMe:propargyl acetate | 2:1 | 8.0 | 1.15 | 1.505 | 1.518 | 0.01 |
| Me-AspOMe:diphenylacetylene | 2:1 | 8.0 | 1.19 | 1.548 | 1.598 | 0.05 |

At the same time, the rates of polymerization for Me-AspOMe were reduced by a factor of two for the alkynes studied here. In general, the Me-AspOMe conversions obtained from ¹H NMR analysis for the copolymerization products showed values that indicate the reaction of the dithiolane with alkynes was favored over dithiolane homopolymerization. This is in contrast to the behavior observed for LipOMe:yne systems, wherein dithiolane homopolymerization was significant during the mixed mode copolymerizations. Table S4 shows GPC results for Me-AspOMe and alkynes studied. Surprisingly low molecular weights for the copolymerization of Me-AspOMe and alkynes were obtained despite the high degree of conversion (Table S5) and changes in refractive indices from resin to polymer, which reached values of 0.06 for the Me-AspOMe:phenylacetylene 4:1, 2:1, and 1:1 ratio. The reaction products for the composition Me-AspOMe:phenylacetylene in a 2:1 ratio were separated using a Biotage automatic chromatography column instrument with hexane:ethyl acetate (80:20) as eluent, two fractions were obtained and analyzed by ¹H and ¹³C NMR. As expected for polymeric structures, the ¹H NMR of one minority product isolated is quite complex and shows broad signals. Peaks found between 8.0-7.5 ppm corroborated the presence of phenyl rings, while signals at 3.7-3.5 ppm, 3.3-3.0 ppm, and 1.5-1.2 ppm ranges correspond to CH₂ and CH₃ groups associated with the opening of the dithiolane ring.

TABLE S5
Compositions, monomer ratios, alkynes final conversions by FTIR
(verified by ¹H NMR for terminal alkynes), polymerization rates
from conversion versus time plots obtained by FTIR, and Me-AspOMe conversion
obtained by ¹H NMR (representative samples). All samples were irradiated
between KBr discs with a light intensity of 40 mW/cm², with 450-500
nm filtered light for 600 s.

| | | % Yne | Reaction | % Dithiolane |
|---|---|---|---|---|
| | | Conversion | Rate | Conversion |
| Composition | Ratio | by FT-IR | (s⁻¹) × 10⁻³ | by ¹H NMR |
| Me-AspOMe:phenylacetylene | 4:1 | >99 ± 1 | 5 | 65 |
| Me-AspOMe:phenylacetylene | 2:1 | 86 ± 1 | 4 | 58 |
| Me-AspOMe:phenylacetylene | 1:1 | 65 ± 1 | 3 | 61 |
| Me-AspOMe:phenylacetylene | 1:2 | 58 ± 1 | 1 | 78 |
| Me-AspOMe:1-octyne | 2:1 | 79 ± 1 | 3 | 76 |
| Me-AspOMe:propargyl acetate | 2:1 | 14 ± 3 | 2 | 49 |
| Me-AspOMe:diphenylacetylene | 2:1 | 10 ± 1 | 5 | 2 |

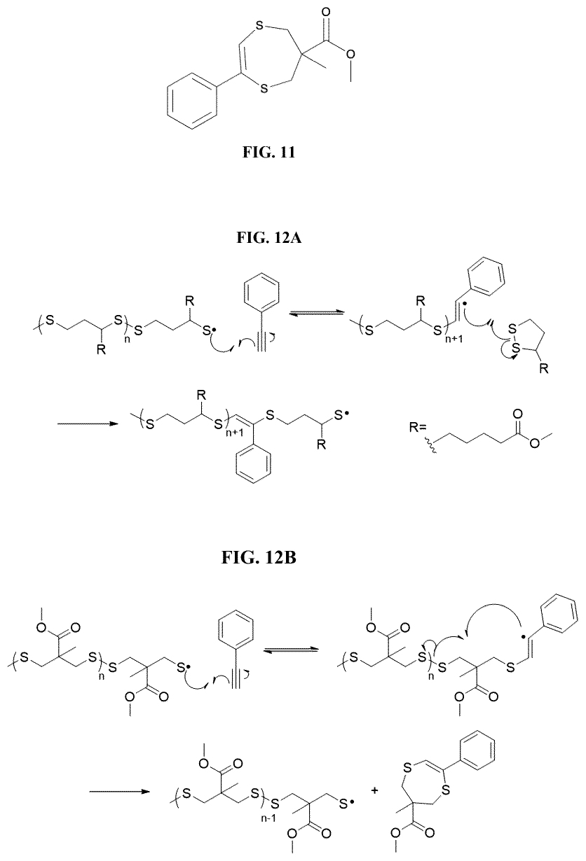

It is noteworthy to mention the peak around 6.5 ppm, which is attributed to the presence of a vinyl sulfide unit within the polymer chain. The obtained integration of phenyl groups to methyl groups indicates a polymeric structure with one phenyl group per two disulfide groups and a molecular weight of −13 kDa (Table S4). Without being bound by theory, it is believed that the mechanism of incorporation of an alkyne into a dithiolane polymer involves the propagation of a single thiyl radical within a growing polydisulfide across the triple bond, resulting in a carbon-centered radical that adds to another dithiolane molecule (FIG. 12A). The ¹H NMR in CDCl₂ of the second product isolated showed aside from the presence of unreacted Me-AspOMe, a singlet centered at 6.09 ppm, which is the region of ¹H NMR spectra associated with vinylic (CvCH) protons, indicating the potential addition of one dithiolane to one yne. Furthermore, the presence of 5 aromatic protons in the range of 7.51-7.29 ppm, signals at 3.97-3.92 (m), 3.74 (s), 3.543.48 (m), and 1.44 (s) together with the corresponding ¹³C NMR are consistent with the mono-addition product (intramolecular cyclization), indicating the presence of the vinyl sulfide [6-methyl,6′-methylesther-2-phenyl-5,7dihydro-1,4-dithiepin] with a chemical structure similar to the one shown on FIG. 12B.

Findings were verified by LC-MS as the mass for charge ratio obtained m/z: 280.06 (41.6%), 281.07 (M+, 100%), 282.07 (20.8%), 283.06 (10.4%), 283.14 (3.2%) matches the expected values for the proposed chemical structure. The 0.4 ppm difference in the chemical shift of the vinyl proton (C═CH) between the polymer (6.5 ppm) and the vinyl sulfide (dithiepin) (6.1 ppm) is not unexpected. This variation is likely due to the positioning of the vinyl proton in relation to the phenyl ring. In the isolated dithiepin, the vinyl proton is positioned cis to the phenyl ring. Thus, the vinyl proton appears at a slightly higher field, meaning its chemical shift is lower due to the shielding effect of the aromatic ring when compared to the vinyl proton trans to the phenyl ring in the proposed mechanism for polymer formation. Vinyl sulfides (dithiepins) analogous to the one obtained here, have been reported for the reaction of 4,4-disubstituted 1,2-dithiolanes derivatives (polymerization-resistant) with acetylenide anions in tert-butyl alcohol in the presence of catalytic amounts of tert-BuOK or lithium butyl acetylenide which gave the corresponding ring-opening products that isomerize to vinylene-insertion products in protic solvents.

Without being bound by theory, a likely mechanism for forming the isolated vinyl sulfide (dithiepin) is analogous to the one described in FIG. 12B. A carbon-centered radical can be formed by the propagation of a single thiyl radical within the growing polydisulfide across the triple bond, but in this case, the radical undergoes chain transfer, kicking out a thiyl radical and forming the vinyl sulfide. Other alkynes studied here are presumed to add similarly to LipOMe and Me-AspOMe, as a closer observation of their FT-IR spectra during copolymerization showed the vinyl sulfide peak around 1530 and 1545 cm¹, respectively.

### Holographic Recording Using 1,2-Dithiolane-Yne Chemistry in a Two-Stage Photopolymer

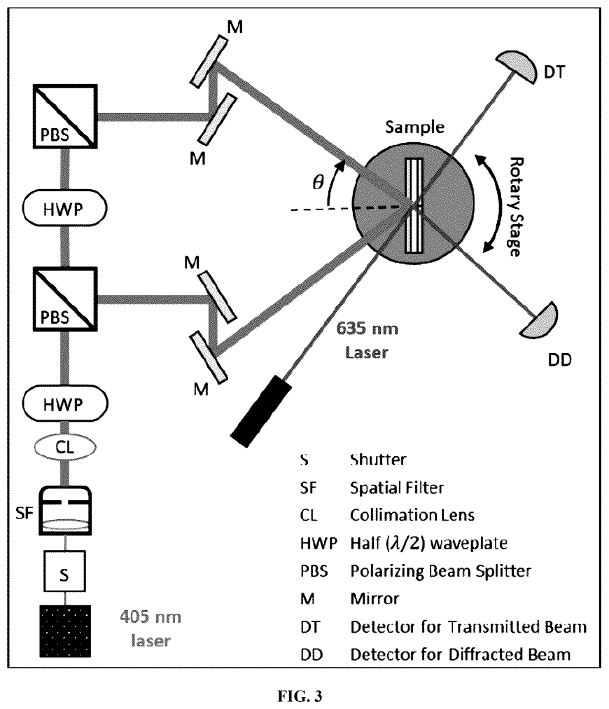

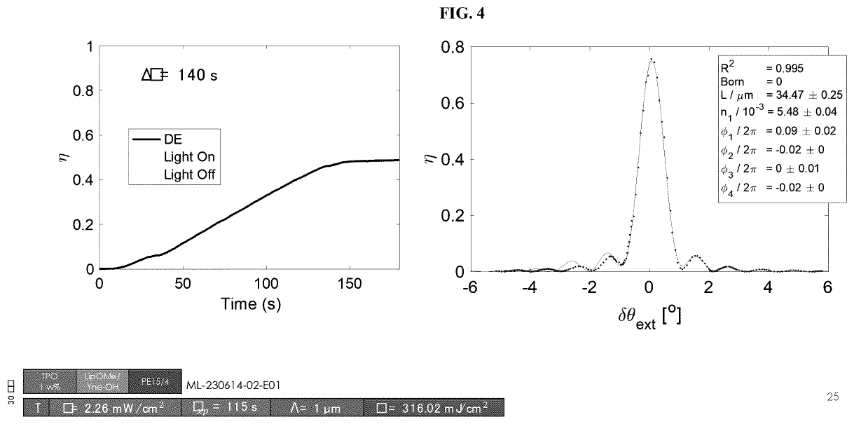

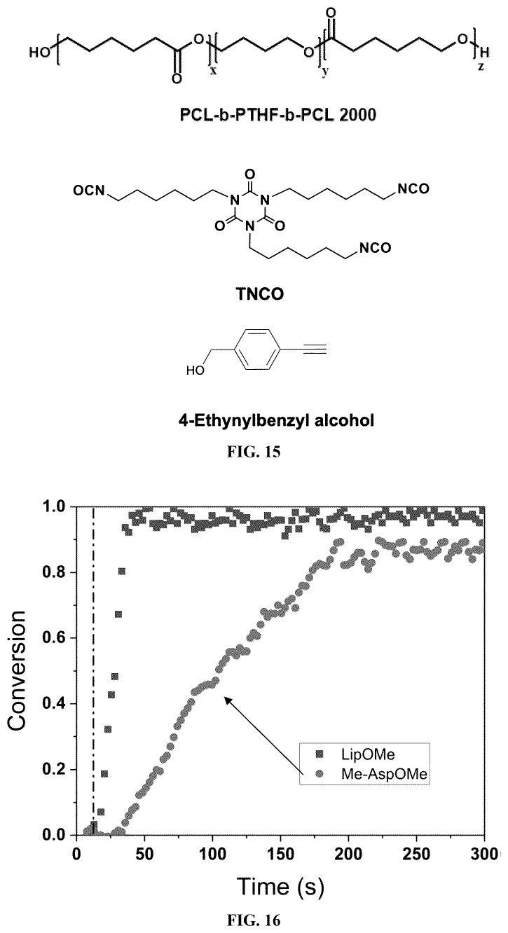

A photopolymer material containing, in various embodiments, a low refractive index polyurethane matrix of polyol 2000/Desmodur N3900 (TNCO) trifunctional isocyanate (nD=1.478, measured at 20° C. and λ=589 nm) as a base polymer material, alkyne pendant groups of 4-ethynyl benzyl alcohol (10 wt % of total matrix weight), 30 wt % of LipOMe (based on total weight) which correspond to a molar ratio of 2:1 dithiolane to alkyne and 1 wt % TPO as a radical photoinitiator (based on monomer weight) (FIG. 15) was prepared by casting a ˜30 μm thick layer between glass microscope slides and tested by recording volume holographic phase transmission gratings into the material using a two-beam interference setup (FIG. 3). The type of base polymer material is not particularly limited, and can include, without limitation, polyacrylate, polyacrylamide, DuPont HRF-600-1, DMP-128, DuPont HRF-150-38, polymethylmethacrylate, epoxy-polyvinyl co-polymers, and the like.

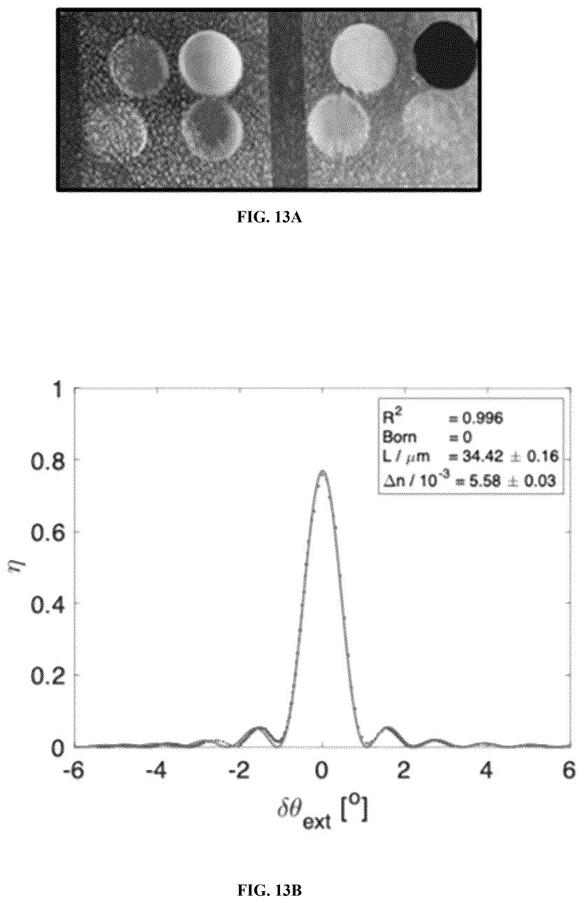

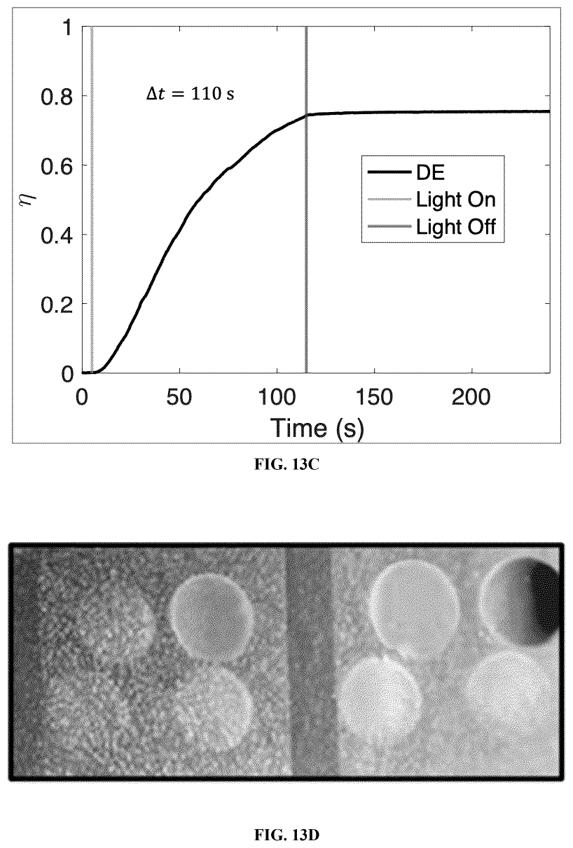

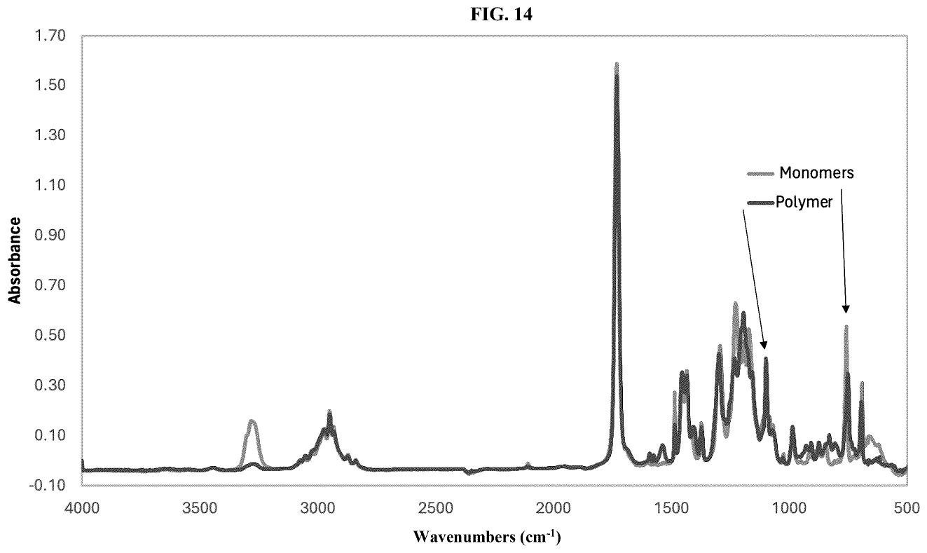

It is worth mentioning that a higher ratio of dithiolane to yne (4:1) was also explored; however, it resulted in material compositions that do not fully form transparent films suitable for holographic recording. FIG. 13A shows a photo of holograms illuminated near the Bragg incidence. FIG. 13B shows the angular playback diffraction efficiency (i) response about the Bragg condition of a representative transmission grating with fits to Kogelnik's coupled wave theory. This unslanted transmission hologram has a period of Λ=650 nm and was recorded using s-polarized λ₀=405 nm light at an irradiance of 3.7 mW cm⁻² for 110 s. The quality of the fit (R²=0.996) indicates minimal fringe distortion and high fringe fidelity. The peak-to-mean refractive index contrast (Δn) of 0.006 obtained is comparable with the value described by Hata et al. of 0.008 utilizing silica nanoparticle-polymer composites based on thiol-yne photopolymers. 26 More recently, Bowman and coworkers recorded transmission holograms in a thiol-yne formulation which exhibited Δn of 0.02 (λ₀=405 nm, I=16 mW cm⁻²); however, diffusional blurring induced by the incomplete conversion of the writing monomers reduced the overall index contrast and remaining a limitation in achieving high index modulation. FIG. 13C shows the grating contrast development by non-destructively monitoring the diffraction efficiency at the Bragg condition during and after the optical exposure. No signal decay was observed after the exposure, indicating stable gratings. Holograms are stable at room temperature after a year of storage (FIG. 13D). A step further in evaluating the optical films was measuring the material birefringence. Birefringence is the polarization dependent response of a material's interaction with light due to an anisotropic refractive index orientation.

The difference in the material refractive index was evaluated by measuring s-polarized (TE) and p-polarized (TM) incident light via prism coupling. Photopolymer samples with 30 wt % based on the total formulation weight of a 1,2-dithiolane-yne system composed of LipOMe and 4-ethyl benzyl alcohol (in a 2:1 ratio) within a urethane matrix exhibited birefringence values at the lower limits of detection for the prism coupler, δₙ=7±8×10⁻⁴ at 636 nm, indicating that the cured medium was essentially non-birefringent. Birefringence is known to be proportional to internal stress distributions within a material and is often related to stress-inducing processes like volume shrinkage. The low birefringence values potentially result from shrinkage compensation during polymerization due to the ring opening of the 1,2-dithiolane monomer or other contributing factors that can mitigate the development of internal stresses like dynamic bond exchange during polymerization of the disulfides noticed by Keyser et al. during their research.

### Compositions

Compounds of the disclosure herein relate to compounds that are useful as optical materials, among other applications.

In some embodiments, provided herein is a composition comprising a polymer. In some embodiments, the polymer is prepared by contacting a compound of Formula (I):

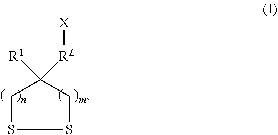

wherein
   m and n are integers and the sum of m and n is 2, 3, or 4;
   R¹ is H or C₁-C₆ alkyl;
   R^{L} is —(CH₂)ₚ—, —(OCH₂—CH₂)ₚ—, —(CHR^{L1})ₘ₁—O—(CHR^{L2}—CHR^{L3}—O)ₘ₂—(CHR^{L4})ₘ₃—C(O)—, —C(O)—(CHR^{L4})ₘ₃—(O—CHR^{L3}—CHR^{L2})ₘ₂—O—(CHR^{L1})ₘ₁—, —(CH₂)ₘ₁—Z¹—[(CH₂)ₘ₄Z²]ₘ₂—(CH₂)ₘ₃—Z³—, or
      —Z³—(CH₂)ₘ₃—[Z²(CH₂)ₘ₄]ₘ₂—Z¹—(CH₂)ₘ₁—;
   m1, m2, and m3 are each independently an integer from 0 to 20;
   m4 is an integer from 0 to 4;
   p is an integer from 1 to 7;
   r is an integer from 1 to 7;
   R^{Z} is independently at each occurrence H or C₁-C₆ alkyl;
   Z¹, Z², and Z³ are each independently absent (a bond), —O—, —S—, —NR^{L5}—, —C(O)—NR^{L5}—, or —NR^{L5}—C(O)—, wherein each R^{L5} is independently selected from the group consisting of hydrogen, C₁-C₆ alkyl, C₆-C₁₀ aryl, C₅-C₁₀ heteroaryl, C₃-C₈ cycloalkyl, and C₃-C₈ cycloheteroalkyl, each of which is optionally substituted by 1 to 3 groups selected from the group consisting of halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)₁₋₂R^{Z}.
   R^{L1}, R^{L2}, R^{L3}, and R^{L4} are each independently selected from the group consisting of hydrogen, C₆-C₁₀ aryl, C₁-C₆ alkyl, C₃-C₈ cycloalkyl, C₅-C₁₀ heteroaryl, and C₃-C₈ cycloheteroalkyl, each of which are optionally substituted by 1 to 3 groups selected from the group consisting of halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, —S(O)₁₋₂R^{Z};
   X is —C(R^{X})₃, —OR^{X}, N(R^{X})₂, —S—R^{X}, —S—S—R^{X}, —CH(SR^{X})₂, —C(O)—R^{X}, —C(O)—OR^{X}, —C(O)N(R^{X})₂, —C₆₋₁₀ aryl optionally substituted by 1 to 6 R^{X} groups, —NH—C(O)—R^{X}, or —NH—C(O)—N(R^{X})₂,wherein each occurrence of R^{X} is independently selected from the group consisting of H, halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)₁₋₂R^{Z};
      with an alkyne of Formula (II):

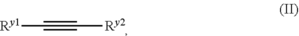

wherein
R^{y1} and R^{y2} are selected from the group consisting of hydrogen, C₆-C₁₀ aryl, C₁-C₆ alkyl, C₃-C₈ cycloalkyl, C₅-C₁₀ heteroaryl, and C₃-C₈ cycloheteroalkyl, each of which are optionally substituted by 1 to 3 groups selected from the group consisting of halogen, —CN, —C(O)—R^{Z}, —O—C(O)—R^{Z}, —(CH₂)ᵣC(O)—O—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)₁₋₂R^{Z}, provided that at least one of R^{y1} and R^{y2} is not hydrogen;
or wherein R^{y1} and R^{y2} are fused to form an 8 to 13-membered cycloalkyl ring, which is optionally substituted by 1 to 3 groups selected from the group consisting of halogen, C₆-C₁₀ aryl, C₁-C₆ alkyl, C₃-C₈ cycloalkyl, C₅-C₁₀ heteroaryl, and C₃-C₈ cycloheteroalkyl, each of which are optionally substituted by 1 to 3 groups selected from the group consisting of H, halogen, —CN, —C(O)—R^{Z}, —O—C(O)—R^{Z}, NR^{Z}R^{Z}, —NO₂, —OR^{Z}, —NR^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)₁₋₂R^{Z}.

In some embodiments, the compound of Formula (I) has the structure:

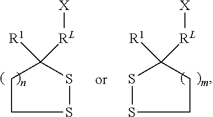

in which n is 1, 2, or 3 or m is 1, 2, or 3.

In some embodiments, provided herein is a composition comprising the reaction product of a compound of Formula (I) and an alkyne of Formula (II):
wherein the compound of Formula (I) has the structure:
wherein

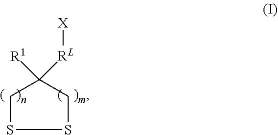

m and n are integers and the sum of m and n is 2, 3, or 4;
   R¹ is H or C₁-C₆ alkyl;
   R^{L} is —(CH₂)ₚ—, —(OCH₂—CH₂)ₚ—, —(CHR^{L1})ₘ₁—O—(CHR^{L2}—CHR^{L3}—O)ₘ₂—(CHR^{L4})ₘ₃—C(O)—, —C(O)—(CHR^{L4})ₘ₃—(O—CHR^{L3}—CHR^{L2})ₘ₂—O—(CHR^{L1})ₘ₁—, —(CH₂)ₘ₁—Z¹—[(CH₂)ₘ₄Z²]ₘ₂—(CH₂)ₘ₃—Z³—, or —Z³—(CH₂)ₘ₃—[Z²(CH₂)ₘ₄]ₘ₂—Z¹—(CH₂)ₘ₁—, wherein p is an integer from 1 to 7;
   m1, m2, and m3 are each independently an integer from 0 to 20;
   m4 is an integer from 0 to 4;
   Z¹, Z², and Z³ are each independently absent (a bond), —O—, —S—, —NR^{L5}—, —C(O)—NR^{L5}—, or —NR^{L5}C(O)—, wherein each R^{L5} is independently selected from the group consisting of hydrogen, C₁-C₆ alkyl, C₆-C₁₀ aryl, C₅-C₁₀ heteroaryl, C₃-C₈ cycloalkyl, and C₃-C₈ cycloheteroalkyl, each of which is optionally substituted by 1 to 3 groups selected from the group consisting of halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, —S(O)₁₋₂R^{Z};
   R^{L1}, R^{L2}, R^{L3}, and R^{L4} are each independently hydrogen, C₆-C₁₀ aryl, C₁-C₆ alkyl, C₃-C₈ cycloalkyl, C₅-C₁₀ heteroaryl, and C₃-C₈ cycloheteroalkyl, each of which are optionally substituted by 1 to 3 groups selected from the group consisting of halogen, —CN, —C(O)—R^{Z}, —O—C(O)—R^{Z}, NR^{Z}R^{Z}, —NO₂, —R^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, —S(O)₁₋₂R^{Z};
   X is —C(R^{X})₃, —OR^{X}, N(R^{X})₂, —S—R^{X}, —S—S—R^{X}, —CH(SR^{X})₂, —C(O)—R^{X}, —C(O)—OR^{X}, —C(O)N(R^{X})₂, —C₆₋₁₀ aryl optionally substituted by 1 to 6 R^{X} groups, —NH—C(O)—R^{X}, or —NH—C(O)—N(R^{X})₂,wherein each occurrence of R^{X} is independently selected from the group consisting of H, halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)₁₋₂R^{Z};
      wherein the alkyne of Formula (II) is:

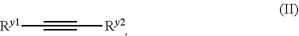

wherein
R^{y1} and R^{y2} are selected from the group consisting of hydrogen, C₆-C₁₀ aryl, C₁-C₆ alkyl, C₃-C₈ cycloalkyl, C₅-C₁₀ heteroaryl, and C₃-C₈ cycloheteroalkyl, each of which are optionally substituted by 1 to 3 groups selected from the group consisting of halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, —S(O)₁₋₂R^{Z}, provided that at least one of R^{y1} and R^{y2} is not hydrogen;
   or wherein R^{y1} and R^{y2} are fused to form an 8 to 13-membered cycloalkyl ring, which is optionally substituted by 1 to 3 groups selected from the group consisting of halogen, C₆-C₁₀ aryl, C₁-C₆ alkyl, C₃-C₈ cycloalkyl, C₅-C₁₀ heteroaryl, and C₃-C₈ cycloheteroalkyl, each of which are optionally substituted by 1 to 3 groups selected from the group consisting of H, halogen, —CN, —C(O)—R^{Z}, —O—C(O)—R^{Z}, NR^{Z}R^{Z}, —NO₂, —OR^{Z}, —NR^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, —S(O)₁₋₂R^{Z}, wherein R^{Z} are each independently H or C₁-C₆ alkyl.

In some embodiments, the composition comprising the reaction product of a compound of Formula (I) and an alkyne of Formula (II) the composition further includes about 0.001 to about 20% (w/w) of a compound of Formula (III):

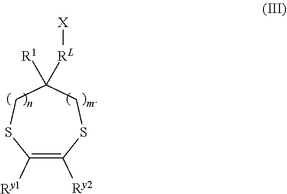

In some embodiments, the compound of Formula (III) has the structure:

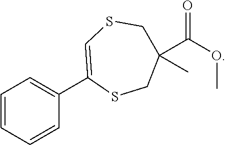 [SMILES: COC(=O)C1(C)CSC=C(c2ccccc2)SC1]

In some embodiments, the compound of Formula (III) is present in an amount of about 0.001 to about 1% (w/w) relative to the weight of the composition. In some embodiments, the compound of Formula (III) is present in an amount of about 0.1 to about 10% (w/w) relative to the weight of the composition. In some embodiments, the compound of Formula (III) is present in an amount of about 0.001 to about 0.01% (w/w) relative to the weight of the composition. In some embodiments, the compound of Formula (III) is present in an amount of about 0.1 to about 20% (w/w) relative to the weight of the composition. In some embodiments, the compound of Formula (III) is present in an amount of about 5 to about 20% (w/w) relative to the weight of the composition. In some embodiments, the compound of Formula (III) is present in the composition in an amount that is at least, equal to, or greater than about 0.001, 0.005, 0.01, 0.05, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19 or about 20% (w/w) relative to the weight of the composition.

In some embodiments, m is 0. In some embodiments, m is 1. In some embodiments, n is 0. In some embodiments, n is 1. In some embodiments, the sum of m and n is 2. In some embodiments, the sum of m and n is 3. In some embodiments, the sum of m and n is 4. In some embodiments, m is 0 and n is 2. In some embodiments, n is 0 and m is 2. In some embodiments, m is 0, and n is 2, 3, or 4. In some embodiments, n is 0, and m is 2, 3, or 4.

In some embodiments, the compound of Formula (I) is

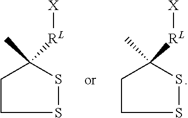

In some embodiments, R^{L} is —(CH₂)ₚ—, wherein p is an integer from 1 to 7. In some embodiments, p is 1. In some embodiments, p is 2. In some embodiments, p is 3. In some embodiments, p is 4. In some embodiments, p is 5. In some embodiments, p is 6. In some embodiments, p is 7.

In some embodiments, R¹ is methyl. In some embodiments, R¹ is hydrogen.

In some embodiments, the compound of Formula (I) is:

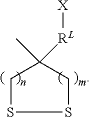

In some embodiments, the compound of Formula (I) is:

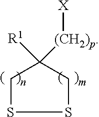

In some embodiments, the compound of Formula (I) is:

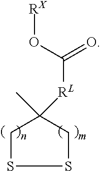

In some embodiments, the compound of Formula (I) is selected from the group consisting of:

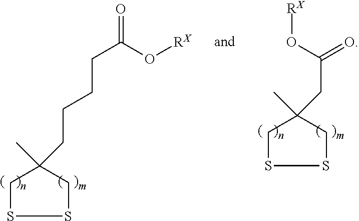

In some embodiments, the compound of Formula (I) is

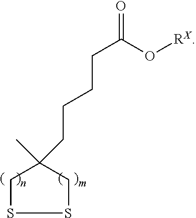

In some embodiments, the compound of Formula (I) is

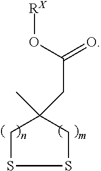

In some embodiments, the compound of Formula (I) is

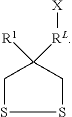

In some embodiments, the compound of Formula (I) is selected from the group consisting

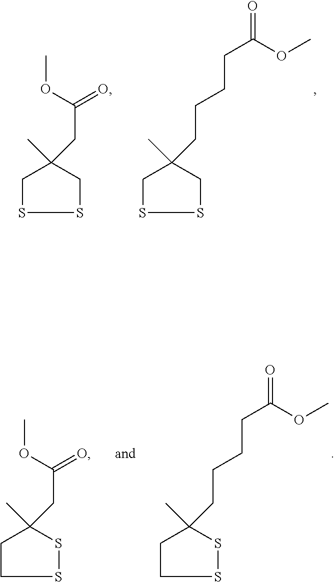

In some embodiments, the compound of Formula (I) is

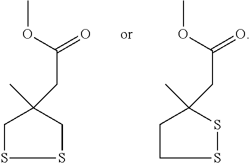

In some embodiments, the compound of Formula (I) is

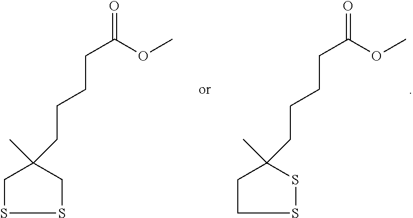

In some embodiments, the compound of Formula (I) is:

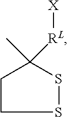

wherein R^{L}—X is —(CH₂)C(═O)OCH₃ or —(CH₂)₄C(═O)OCH₃.

In some embodiments, X is:

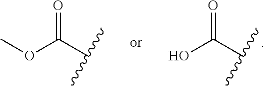

In some embodiments, X is

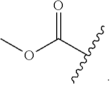 [SMILES: *C(=O)OC]

In some embodiments, X is

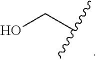 [SMILES: *CO]

In some embodiments, R^{y2} is H.

In some embodiments, R^{y1} and R^{y2} are each independently selected from the group consisting of hydrogen, phenyl, methyl, and —(CH₂)ᵣC(O)—O—R^{Z}, wherein R^{Z} is selected from C₁-C₆ alkyl, and wherein r is an integer from 1 to 7.

In some embodiments, the alkyne of Formula (II) is selected from the group consisting of: phenylacetylene, 1-octyne, propargyl acetate, methyl propargyl ether, cyclooctyne, ethyl propiolate, methyl propargylamine, 2-octyne, dimethylacetylenedicarboxylate, 1,9-decadiyne, ethyl phenylpropiolate, and diphenylacetylene. In some embodiments, the alkyne of Formula (II) is 1-octyne. In some embodiments, the alkyne of Formula (II) is phenylacetylene. In some embodiments, the alkyne of Formula (II) is propargyl acetate. In some embodiments, the alkyne of Formula (II) is diphenylacetylene. In some embodiments, the alkyne of Formula (II) is methyl propargyl ether. In some embodiments, the alkyne of Formula (II) is cyclooctyne. In some embodiments, the alkyne of Formula (II) is ethyl propiolate. In some embodiments, the alkyne of Formula (II) is methyl propargylamine. In some embodiments, the alkyne of Formula (II) is 2-octyne. In some embodiments, the alkyne of Formula (II) is dimethylacetylenedicarboxylate. In some embodiments, the alkyne of Formula (II) is 1,9-decadiyne. In some embodiments, the alkyne of Formula (II) is ethyl phenylpropiolate,

In some embodiments, the reaction product of the compound of Formula (I) and the alkyne of Formula (II) is a polymer. In some embodiments, the polymer has a number average molecular weight from about 500 Da to about 50,000 Da. In some embodiments, the polymer has a number average molecular weight from about 500 Da to about 5,000 Da. In some embodiments, the polymer has a number average molecular weight from about 5,000 Da to about 50,000 Da. In some embodiments, the polymer has a number average molecular weight from about 1,000 Da to about 100,000 Da. In some embodiments, the polymer has a number average molecular weight from about 100 Da to about 10,000 Da. In some embodiments, the polymer has a number average molecular weight from about 1,000 Da to about 10,000 Da. In some embodiments, the polymer has a number average molecular weight from about 10,000 Da to about 100,000 Da.

In some embodiments, the polymer has a weight average molecular weight from about 500 Da to about 50,000 Da. In some embodiments, the polymer has a weight average molecular weight from about 500 Da to about 5,000 Da. In some embodiments, the polymer has a weight average molecular weight from about 5,000 Da to about 50,000 Da. In some embodiments, the polymer has a weight average molecular weight from about 1,000 Da to about 100,000 Da. In some embodiments, the polymer has a weight average molecular weight from about 100 Da to about 10,000 Da. In some embodiments, the polymer has a weight average molecular weight from about 1,000 Da to about 10,000 Da. In some embodiments, the polymer has a weight average molecular weight from about 10,000 Da to about 100,000 Da.

In some embodiments, the polymer has a number average or weight average molecular weight of at least, equal to, or greater than about 500, 600, 700, 800, 900, 1,000, 1,100, 1,200, 1,300, 1,400, 1,500, 1,600, 1,700, 1,800, 1,900, 2,000, 2,100, 2,200, 2,300, 2,400, 2,500, 2,600, 2,700, 2,800, 2,900, 3,000, 3,100, 3,200, 3,300, 3,400, 3,500, 3,600, 3,700, 3,800, 3,900, 4,000, 4,100, 4,200, 4,300, 4,400, 4,500, 4,600, 4,700, 4,800, 4,900, 5,000, 5,100, 5,200, 5,300, 5,400, 5,500, 5,600, 5,700, 5,800, 5,900, 6,000, 6,100, 6,200, 6,300, 6,400, 6,500, 6,600, 6,700, 6,800, 6,900, 7,000, 7,100, 7,200, 7,300, 7,400, 7,500, 7,600, 7,700, 7,800, 7,900, 8,000, 8,100, 8,200, 8,300, 8,400, 8,500, 8,600, 8,700, 8,800, 8,900, 9,000, 9,100, 9,200, 9,300, 9,400, 9,500, 9,600, 9,700, 9,800, 9,900, 10,000, 11,000, 12,000, 13,000, 14,000, 15,000, 16,000, 17,000, 18,000, 19,000, 20,000, 25,000, 30,000, 35,000, 40,000, 45,000, or about 50,000 Da.

In some embodiments, the polymer has a number average or weight average molecular weight of at least, greater than, or equal to about 2,000, 2,100, 2,200, 2,300, 2,400, 2,500, 2,600, 2,700, 2,800, 2,900, 3,000, 3,100, 3,200, 3,300, 3,400, 3,500, 3,600, 3,700, 3,800, 3,900, or about 4000 Da. In some embodiments, at least 50, 55, 60, 65, 70, 75, 80, 85, 90, 95, 96, 97, 98, 99, or 100% (w/w) of the polymer has a number average or weight average molecular weight of about 2000 Da to about 4000 Da, or a number average or weight average molecular weight of at least, greater than, or equal to about 2,000, 2,100, 2,200, 2,300, 2,400, 2,500, 2,600, 2,700, 2,800, 2,900, 3,000, 3,100, 3,200, 3,300, 3,400, 3,500, 3,600, 3,700, 3,800, 3,900, or about 4000 Da.

In some embodiments, the refractive index of the reaction product (polymer) is from about 1.45 to 1.80. In some embodiments, the refractive index of the reaction product (polymer) is from about 1.45 to 1.60. In some embodiments, the refractive index of the reaction product (polymer) is at least, greater than, or equal to 1.45, 1.46, 1.47, 1.48, 1.49, 1.50, 1.51, 1.52, 1.53, 1.54, 1.55, 1.56, 1.57, 1.58, 1.59, 1.60, 1.61, 1.62, 1.63, 1.64, 1.65. 1.66, 1.67, 1.68, 1.69, 1.70, 1.71, 1.72, 1.73, 1.74, 1.75, 1.76, 1.77, 1.78, 1.79, or 1.80.

In some embodiments, the refractive index is about 1.45. In some embodiments, the refractive index is about 1.46. In some embodiments, the refractive index is about 1.48. In some embodiments, the refractive index is about 1.49. In some embodiments, the refractive index is about 1.50. In some embodiments, the refractive index is about 1.51. In some embodiments, the refractive index is about 1.52. In some embodiments, the refractive index is about 1.52. In some embodiments, the refractive index is about 1.53. In some embodiments, the refractive index is about 1.54. In some embodiments, the refractive index is about 1.55. In some embodiments, the refractive index is about 1.56. In some embodiments, the refractive index is about 1.57. In some embodiments, the refractive index is about 1.58. In some embodiments, the refractive index is about 1.59. In some embodiments, the refractive index is about 1.60. In some embodiments, the refractive index is about 1.61. In some embodiments, the refractive index is about 1.62. In some embodiments, the refractive index is about 1.63. In some embodiments, the refractive index is about 1.64. In some embodiments, the refractive index is about 1.65. In some embodiments, the refractive index is about 1.66. In some embodiments, the refractive index is about 1.67. In some embodiments, the refractive index is about 1.68. In some embodiments, the refractive index is about 1.69. In some embodiments, the refractive index is about 1.70. In some embodiments, the refractive index is about 1.71. In some embodiments, the refractive index is about 1.72. In some embodiments, the refractive index is about 1.73. In some embodiments, the refractive index is about 1.74. In some embodiments, the refractive index is about 1.75. In some embodiments, the refractive index is about 1.76. In some embodiments, the refractive index is about 1.77. In some embodiments, the refractive index is about 1.78. In some embodiments, the refractive index is about 1.79. In some embodiments, the refractive index is about 1.80.

In some embodiments, the polymer is optically isotropic. In some embodiments, the polymer is adapted for use in optical materials and applications. The polymer, or a composition thereof, may be used as an optical lens, prism, window, waveguide, mirror, or other optical instrument.

In some embodiments, an article of manufacture that includes the polymer composition(s) described herein can be fashioned into an optical tool such as a lens, a waveguide, a lithograph, a hologram, a window, a prism, a mirror, and a combination thereof. In some embodiments, the polymer or compositions thereof described herein may form non-linear optical materials.

### Preparation of Compounds

Compounds described herein can be prepared by the general schemes described herein, using the synthetic method known by those skilled in the art. The following examples illustrate non-limiting embodiments of the compound(s) described herein and their preparation.

The compounds described herein can possess one or more stereocenters, and each stereocenter can exist independently in either the (R) or (S) configuration. In certain embodiments, compounds described herein are present in optically active or racemic forms. It is to be understood that the compounds described herein encompass racemic, optically-active, regioisomeric and stereoisomeric forms, or combinations thereof that possess the therapeutically useful properties described herein. Preparation of optically active forms is achieved in any suitable manner, including by way of non-limiting example, by resolution of the racemic form with recrystallization techniques, synthesis from optically-active starting materials, chiral synthesis, or chromatographic separation using a chiral stationary phase. In certain embodiments, a mixture of one or more isomer is utilized as the therapeutic compound described herein. In other embodiments, compounds described herein contain one or more chiral centers. These compounds are prepared by any means, including stereoselective synthesis, enantioselective synthesis and/or separation of a mixture of enantiomers and/or diastereomers. Resolution of compounds and isomers thereof is achieved by any means including, by way of non-limiting example, chemical processes, enzymatic processes, fractional crystallization, distillation, and chromatography.

The methods and formulations described herein include the use of N-oxides (if appropriate), crystalline forms (also known as polymorphs), solvates, amorphous phases, and/or acceptable salts of compounds having the structure of any compound(s) described herein, as well as metabolites and active metabolites of these compounds having the same type of activity. Solvates include water, ether (e.g., tetrahydrofuran, methyl tert-butyl ether) or alcohol (e.g., ethanol) solvates, acetates and the like. In certain embodiments, the compounds described herein exist in solvated forms with solvents such as water, and ethanol. In other embodiments, the compounds described herein exist in unsolvated form.

In certain embodiments, the compound(s) described herein can exist as tautomers. All tautomers are included within the scope of the compounds presented herein.

In certain embodiments, sites on, for example, the aromatic ring portion of compound(s) described herein are susceptible to various metabolic reactions. Incorporation of appropriate substituents on the aromatic ring structures may reduce, minimize or eliminate this metabolic pathway. In certain embodiments, the appropriate substituent to decrease or eliminate the susceptibility of the aromatic ring to metabolic reactions is, by way of example only, a deuterium, a halogen, or an alkyl group.

Compounds described herein also include isotopically-labeled compounds wherein one or more atoms is replaced by an atom having the same atomic number, but an atomic mass or mass number different from the atomic mass or mass number usually found in nature. Examples of isotopes suitable for inclusion in the compounds described herein include and are not limited to ²H, ³H ¹¹C, ¹³C ¹⁴C, ³⁶Cl, ¹⁸F, ¹²³I, ¹²⁵I, ¹³N, ¹⁵N, ¹⁵O, ¹⁷O, ¹⁸O, ³²P and ³⁵S. In certain embodiments, isotopically-labeled compounds are useful in drug and/or substrate tissue distribution studies. In other embodiments, substitution with heavier isotopes such as deuterium affords greater metabolic stability (for example, increased in vivo half-life or reduced dosage requirements). In yet other embodiments, substitution with positron emitting isotopes, such as ¹¹C, ¹⁸F, ¹⁵O and ¹³N, is useful in Positron Emission Topography (PET) studies for examining substrate receptor occupancy. Isotopically-labeled compounds are prepared by any suitable method or by processes using an appropriate isotopically-labeled reagent in place of the non-labeled reagent otherwise employed.

In certain embodiments, the compounds described herein are labeled by other means, including, but not limited to, the use of chromophores or fluorescent moieties, bioluminescent labels, or chemiluminescent labels.

The compounds described herein, and other related compounds having different substituents are synthesized using techniques and materials described herein and as described, for example, in Fieser & Fieser's Reagents for Organic Synthesis, Volumes 1-17 (John Wiley and Sons, 1991); Rodd's Chemistry of Carbon Compounds, Volumes 1-5 and Supplementals (Elsevier Science Publishers, 1989); Organic Reactions, Volumes 1-40 (John Wiley and Sons, 1991), Larock's Comprehensive Organic Transformations (VCH Publishers Inc., 1989), March, Advanced Organic Chemistry 4^{th} Ed., (Wiley 1992); Carey & Sundberg, Advanced Organic Chemistry 4th Ed., Vols. A and B (Plenum 2000,2001), and Green & Wuts, Protective Groups in Organic Synthesis 3rd Ed., (Wiley 1999) (all of which are incorporated by reference for such disclosure). General methods for the preparation of compound as described herein are modified by the use of appropriate reagents and conditions, for the introduction of the various moieties found in the formula as provided herein.

Compounds described herein are synthesized using any suitable procedures starting from compounds that are available from commercial sources, or are prepared using procedures described herein.

In certain embodiments, reactive functional groups, such as hydroxyl, amino, imino, thio or carboxy groups, are protected in order to avoid their unwanted participation in reactions.

Protecting groups are used to block some or all of the reactive moieties and prevent such groups from participating in chemical reactions until the protective group is removed. In other embodiments, each protective group is removable by a different means. Protective groups that are cleaved under totally disparate reaction conditions fulfill the requirement of differential removal.

In certain embodiments, protective groups are removed by acid, base, reducing conditions (such as, for example, hydrogenolysis), and/or oxidative conditions. Groups such as trityl, dimethoxytrityl, acetal and t-butyldimethylsilyl are acid labile and are used to protect carboxy and hydroxy reactive moieties in the presence of amino groups protected with Cbz groups, which are removable by hydrogenolysis, and Fmoc groups, which are base labile. Carboxylic acid and hydroxy reactive moieties are blocked with base labile groups such as, but not limited to, methyl, ethyl, and acetyl, in the presence of amines that are blocked with acid labile groups, such as t-butyl carbamate, or with carbamates that are both acid and base stable but hydrolytically removable.

In certain embodiments, carboxylic acid and hydroxy reactive moieties are blocked with hydrolytically removable protective groups such as the benzyl group, while amine groups capable of hydrogen bonding with acids are blocked with base labile groups such as Fmoc. Carboxylic acid reactive moieties are protected by conversion to simple ester compounds as exemplified herein, which include conversion to alkyl esters, or are blocked with oxidatively-removable protective groups such as 2,4-dimethoxybenzyl, while co-existing amino groups are blocked with fluoride labile silyl carbamates.

Allyl blocking groups are useful in the presence of acid- and base-protecting groups since the former are stable and are subsequently removed by metal or pi-acid catalysts. For example, an allyl-blocked carboxylic acid is deprotected with a palladium-catalyzed reaction in the presence of acid labile t-butyl carbamate or base-labile acetate amine protecting groups. Yet another form of protecting group is a resin to which a compound or intermediate is attached. As long as the residue is attached to the resin, that functional group is blocked and does not react. Once released from the resin, the functional group is available to react.

Typically blocking/protecting groups may He selected from

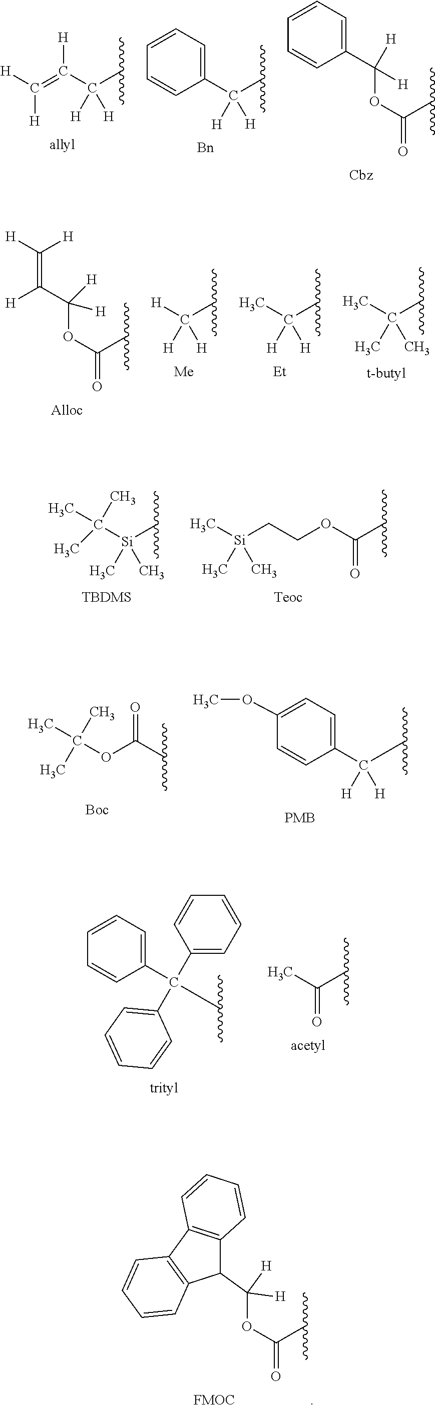

Other protecting groups, plus a detailed description of techniques applicable to the creation of protecting groups and their removal are described in Greene & Wuts, Protective Groups in Organic Synthesis, 3rd Ed., John Wiley & Sons, New York, NY, 1999, and Kocienski, Protective Groups, Thieme Verlag, New York, NY, 1994, which are incorporated herein by reference for such disclosure.

### Methods

In some embodiments, provided herein is a method of generating a polymer. The method includes:
contacting a compound of Formula (I):

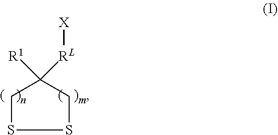

wherein
   m and n are integers and the sum of m and n is 2, 3, or 4;
   R¹ is H or C₁-C₆ alkyl;
   R^{L} is —(CH₂)ₚ—, —(OCH₂—CH₂)ₚ—, —(CHR^{L1})ₘ₁—O—(CHR^{L2}—CHR^{L3}—O)ₘ₂—(CHR^{L4})ₘ₃—C(O)—, —C(O)—(CHR^{L4})ₘ₃—(O—CHR^{L3}—CHR^{L2})ₘ₂—O—(CHR^{L1})ₘ₁—, —(CH₂)ₘ₁—Z¹—[(CH₂)ₘ₄Z²]ₘ₂—(CH₂)ₘ₃—Z³—, or —Z³—(CH₂)ₘ₃—[Z²(CH₂)ₘ₄]ₘ₂—Z¹—(CH₂)ₘ₁—;
   m1, m2, and m3 are each independently an integer from 0 to 20;
   m4 is an integer from 0 to 4;
   p is an integer from 1 to 7;
   r is an integer from 1 to 7;
   R^{Z} is independently at each occurrence H or C₁-C₆ alkyl;
   Z¹, Z², and Z³ are each independently absent (a bond), —O—, —S—, —NR^{L5}—, —C(O)—NR^{L5}—, or —NR^{L5}—C(O)—, wherein each R^{L5} is independently selected from the group consisting of hydrogen, C₁-C₆ alkyl, C₆-C₁₀ aryl, C₅-C₁₀ heteroaryl, C₃-C₈ cycloalkyl, and C₃-C₈ cycloheteroalkyl, each of which is optionally substituted by 1 to 3 groups selected from the group consisting of halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)₁₋₂R^{Z};
   R^{L1}, R^{L2}, R^{L3}, and R^{L4} are each independently selected from the group consisting of hydrogen, C₆-C₁₀ aryl, C₁-C₆ alkyl, C₃-C₈ cycloalkyl, C₅-C₁₀ heteroaryl, and C₃-C₈ cycloheteroalkyl, each of which are optionally substituted by 1 to 3 groups selected from the group consisting of halogen, —CN, —C(O)—R^{Z}, —O—C(O)—R^{Z}, NR^{Z}R, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, —S(O)₁₋₂R^{Z};
   X is —C(R^{X})₃, —OR^{X}, N(R^{X})₂, —S—R^{X}, —C(O)—R^{X}, —C(O)—OR^{X}, —C(O)N(R^{X})₂, —NH—C(O)—R^{X}, —NH—C(O)—N(R^{X})₂,wherein R^{X} are each independently selected from the group consisting of H, halogen, —CN, —C(O)—R^{Z}, —O—C(O)—R^{Z}, NR^{Z}R^{Z}, —NO₂, —OR^{Z}, —NR^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)₁₋₂R^{Z};
      with an alkyne of Formula (II):

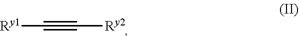

wherein
R^{y1} and R^{y2} are selected from the group consisting of hydrogen, C₆-C₁₀ aryl, C₁-C₆ alkyl, C₃-C₈ cycloalkyl, C₅-C₁₀ heteroaryl, and C₃-C₈ cycloheteroalkyl, each of which are optionally substituted by 1 to 3 groups selected from the group consisting of halogen, —CN, —C(O)—R^{Z}, —O—C(O)—R^{Z}, —(CH₂)ᵣC(O)—O—R^{Z}, NR^{Z}R^{Z}, —NO₂, —R^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)₁₋₂R^{Z}, provided that at least one of R^{y1} and R^{y2} is not hydrogen;
or wherein R^{y1} and R^{y2} are fused to form an 8 to 13-membered cycloalkyl ring, which is optionally substituted by 1 to 3 groups selected from the group consisting of halogen, C₆-C₁₀ aryl, C₁-C₆ alkyl, C₃-C₈ cycloalkyl, C₅-C₁₀ heteroaryl, and C₃-C₈ cycloheteroalkyl, each of which are optionally substituted by 1 to 3 groups selected from the group consisting of H, halogen, —CN, —C(O)—R^{Z}, —O—C(O)—R^{Z}, NR^{Z}R^{Z}, —NO₂, —OR^{Z}, —NR^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)₁₋₂R^{Z}.

In some embodiments, the compound of Formula (I) has the structure:

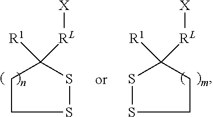

in which n is 1, 2, or 3 or m is 1, 2, or 3.

In some embodiments, m is 0 or 1 and n is 0 or 1. In some embodiments, m is 0. In some embodiments, m is 1. In some embodiments, n is 0. In some embodiments, n is 1.

In some embodiments, R^{L} is —(CH₂)ₚ—, wherein p is an integer from 1 to 7. In some embodiments, p is 1. In some embodiments, p is 2. In some embodiments, p is 3. In some embodiments, p is 4. In some embodiments, p is 5. In some embodiments, p is 6. In some embodiments, p is 7.

In some embodiments, R¹ is methyl. In some embodiments, R¹ is hydrogen.

In some embodiments, the compound of Formula (I) is:

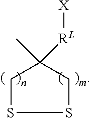

In some embodiments, the compound of Formula (I) is:

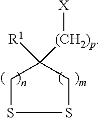

In some embodiments, the compound of Formula (I) is:

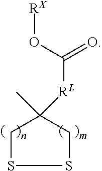

In some embodiments, the compound of Formula (I) is selected from the group consisting of:

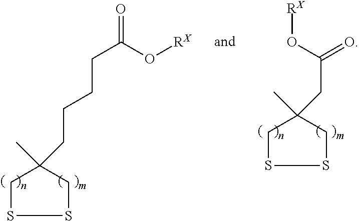

In some embodiments, the compound of Formula (I) is

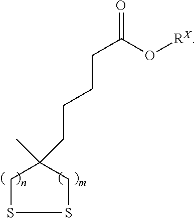

In some embodiments, the compound of Formula (I) is

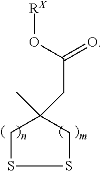

In some embodiments, the compound of Formula (I) is

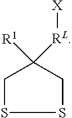

In some embodiments, the compound of Formula (I) is

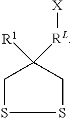

In some embodiments, the compound of Formula (I) is selected from the group consisting of:

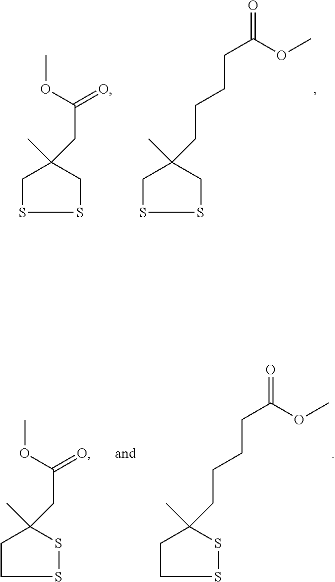

In some embodiments, the compound of Formula (I) is

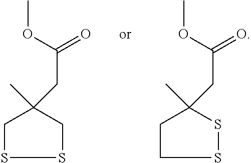

In some embodiments, the compound of Formula (I) is

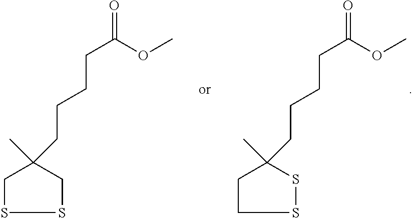

In some embodiments, the compound of Formula (I) is:

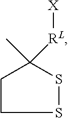

wherein R^{L}—X is —(CH₂)C(═O)OCH₃ or —(CH₂)₄C(═O)OCH₃.

In some embodiments, X is selected from the group consisting of

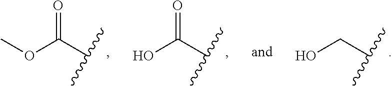

In some embodiments, X is

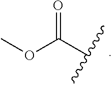 [SMILES: *C(=O)OC]

In some embodiments, X is

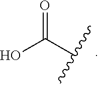 [SMILES: *C(=O)O]

In some embodiments, X is OH or

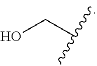 [SMILES: *CO]

In some embodiments, R^{y2} is H.

In some embodiments, R^{y1} and R^{y2} are each independently selected from the group consisting of: H, phenyl, methyl, and —(CH₂)ᵣC(O)—O—R^{Z}, wherein R^{Z} is selected from C₁-C₆ alkyl, and wherein r is an integer from 1 to 7.

In some embodiments, the alkyne of Formula (II) is selected from the group consisting of: phenylacetylene, 1-octyne, propargyl acetate, methyl propargyl ether, cyclooctyne, ethyl propiolate, methyl propargylamine, 2-octyne, dimethylacetylenedicarboxylate, 1,9-decadiyne, ethyl phenylpropiolate, and diphenylacetylene. In some embodiments, the alkyne of Formula (II) is 1-octyne. In some embodiments, the alkyne of Formula (II) is phenylacetylene. In some embodiments, the alkyne of Formula (II) is propargyl acetate. In some embodiments, the alkyne of Formula (II) is diphenylacetylene. In some embodiments, the alkyne of Formula (II) is methyl propargyl ether. In some embodiments, the alkyne of Formula (II) is cyclooctyne. In some embodiments, the alkyne of Formula (II) is ethyl propiolate. In some embodiments, the alkyne of Formula (II) is methyl propargylamine. In some embodiments, the alkyne of Formula (II) is 2-octyne. In some embodiments, the alkyne of Formula (II) is dimethylacetylenedicarboxylate. In some embodiments, the alkyne of Formula (II) is 1,9-decadiyne. In some embodiments, the alkyne of Formula (II) is ethyl phenylpropiolate,

In some embodiments, the method produces a compound of Formula (III):

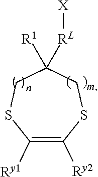

wherein the compound of Formula (III) is present in an amount of from about 0.001 to about 90% (w/w) of the polymer.

In some embodiments, the compound of Formula (III) forms about 0.001 to about 1% (w/w) of the polymer. In some embodiments, the compound of Formula (III) forms about 0.001 to about 1% (w/w) of the polymer. In some embodiments, the compound of Formula (III) forms about 0.1 to about 10% (w/w) of the polymer. In some embodiments, the compound of Formula (III) forms about 0.001 to about 1% (w/w) of the polymer. In some embodiments, the compound of Formula (III) forms about 0.001 to about 0.01% (w/w) of the polymer. In some embodiments, the compound of Formula (III) forms about 0.1 to about 90% (w/w) of the polymer. In some embodiments, the compound of Formula (III) forms about 5 to about 90% (w/w) of the polymer.

In some embodiments, the compound of Formula (III) is present in the composition in an amount that is at least, equal to, or greater than about 0.001, 0.005, 0.01, 0.05, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, or 90% (w/w) relative to the weight of the polymer.

In some embodiments, at least 50, 55, 60, 65, 70, 75, 80, 85, 90, 95, 96, 97, 98, 99, or 100% (w/w) of the polymer formed by the methods described herein has a number average or weight average molecular weight of about 2000 Da to about 4000 Da, or a number average or weight average molecular weight of at least, greater than, or equal to about 2,000, 2,100, 2,200, 2,300, 2,400, 2,500, 2,600, 2,700, 2,800, 2,900, 3,000, 3,100, 3,200, 3,300, 3,400, 3,500, 3,600, 3,700, 3,800, 3,900, or about 4000 Da.

In some embodiments, the contacting further comprises exposing the compound of Formula (I) and the compound of Formula (II) to electromagnetic radiation or thermal radiation.

In some embodiments, the electromagnetic radiation is microwave radiation. In some embodiments, the microwave radiation has a wavelength of from about 30 cm to about 0.3 cm.

In some embodiments, the exposing proceeds for about 1 to about 60 minutes. In some embodiments, the exposing proceeds for at least one, two, three, four, or five hours, or more. In some embodiments, the electromagnetic radiation comprises radiation with a wavelength of about 400 nm to about 500 nm. In some embodiments, the power of the electromagnetic radiation is about 10 mW/cm² to about 100 mW/cm². In some embodiments, the power of the electromagnetic radiation is about 40 mW/cm².

In some embodiments, the exposing further comprises addition of an initiator of a reaction. In some embodiments, the method further comprises adding a catalyst or polymerization initiator. In some embodiments, the catalyst, initiator, or polymerization initiator is a thermal initiator. In some embodiments, the catalyst, initiator, or polymerization initiator is a oxidation-reduction (redox) initiator. In some embodiments, the catalyst, initiator, or polymerization initiator is a non-cleavage initiator. In some embodiments, the catalyst, initiator, or polymerization initiator is a peroxide such as hydrogen peroxide, an inorganic peroxide, or an organic peroxide. In some embodiments, the catalyst, initiator, or polymerization initiator is camphorquinone, azo-iso butyronitrile, chlorine, bromine, iodine, phenone compounds, azonitrile compounds, and the like.

In some embodiments, the catalyst, initiator, or polymerization initiator is activated by exposure to heat, light, or pH changes,

In some embodiments, the method comprises adding a photoinitiator. In some embodiments, the photoinitiator is a type I photoinitiator. In some embodiments, the photoinitiator is a type II photoinitiator. Suitable photoinitiators include, but are not limited to, acetophenone, benzophenone, 2-phenylacetophenone, 2,2-dimethoxy-2-phenylacetophenone, bis(2,4,6-trimethylbenzoyl)-phenylphosphineoxide, 2-hydroxy-4′-(2-hydroxyethoxy)-2-methylpropiophenone, 2-methyl-(4-methylthienyl)-2-morpholinyl-1-propan-1-one, diphenyl(2,4,6-trimethylbenzoyl)phosphine oxide, ethyl (2,4,6-trimethylbenzoyl) phenyl phosphinate, lithium phenyl-2,4,6-trimethylbenzoylphosphinate,

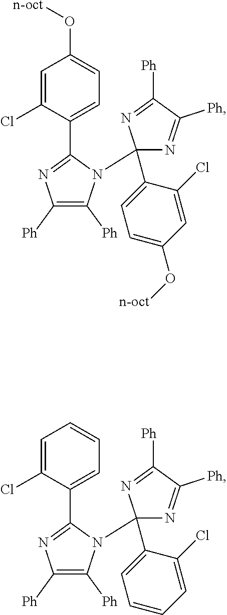

and the like. In some embodiments, the photoinitiator is diphenyl(2,4,6-trimethylbenzoyl)phosphine oxide (TPO).

### EXAMPLES

Various embodiments of the present application can be better understood by reference to the following Examples which are offered by way of illustration. The scope of the present application is not limited to the Examples given herein.

### Methods and Materials

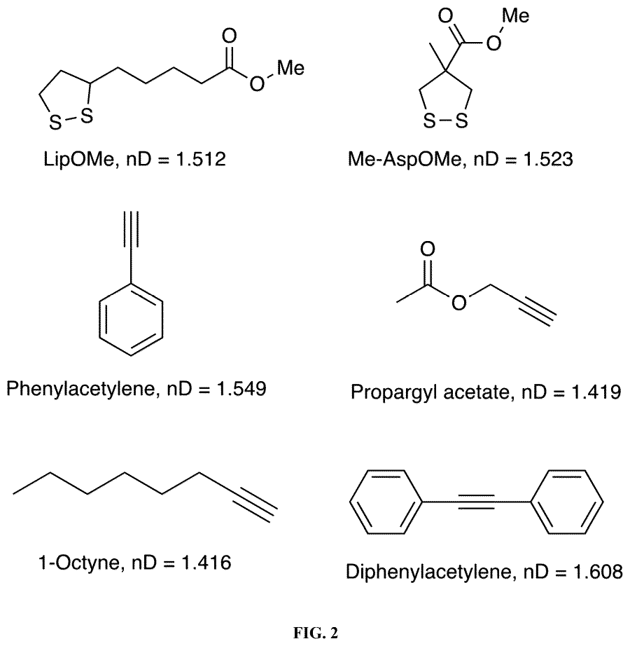

In various embodiments, compounds used in the disclosure include those of FIG. 2. α-lipoic acid, phenylacetylene, 1-octyne, propargyl acetate, diphenylacetylene, diphenyl(2,4,6-trimethyl(benzoyl)phosphine oxide (TPO, purity: 98%), and Polycaprolactone-block-polytetrahydrofuran-block-polycaprolactone (Polyol 2000) were purchased from Aldrich. N,N-diisopropylcarbodiimide (DIC) was purchased from 1PlusChem, and dimethyl aminopyridine (DMPA) was purchased from Oakwood Chemical. Celite, Magnesium sulfate (MgSO₄), sodium sulfate (Na₂SO₄), and sodium carbonate (Na₂CO₃), were purchased from Fisher Scientific. Desmodur N3900 was donated by Covestro LLC. Methyl ester of lipoic acid (LipOMe), 4-Methyl-1,2-dithiolane-4—Carboxylic acid (Me-AspAc) and methyl 4-methyl-1,2-dithiolane-4-carboxylate (Me-AspOMe) were synthesized according to previously procedures described in the literature.

### Formulation Preparation

Each formulation was prepared by placing the appropriate amount of monomer(s) in a 20 mL vial and mixing it with 1 wt % (based on the total monomer concentration) of TPO photoinitiator. The mixtures were stirred using a vortex until a fully homogeneous mixture was formed. Next, vacuum was applied to remove air bubbles from the formulations.

### Nuclear Magnetic Resonance (NMR)

NMR spectra were recorded on a Bruker AVANCE-III 400 NMR spectrometer at 25° C. in deuterated solvent. All chemical shifts are reported in ppm relative to TMS. Equation 1 was used to calculate conversion (C); Iₚ is the integral of the peak associated with the polymer and Iₘ is the integral of the peak associated with the monomer.

$$C = ( \frac{Ip}{Ip + {I}_{m}} ) \times 100 \qquad ( 1 )$$

### Refractive Index Measurements

The refractive index of liquid samples and polymers were measured using an Abbe refractometer (Abbemat MW) at the Fraunhofer lines-sodium-D (589 nm) at room temperature.

The refractive index of polymeric films was measured using a Metricon 2010/M prism coupler at different wavelengths and extrapolated to 589 nm under ambient conditions. The refractive index of the alkynes studied are reported in Table 1.

TABLE 1
nD values of various alkynes at 20° C.

| Compound | nD Alkynes (589.3 nm, 20° C.) |
|---|---|
| Phenylacetylene | 1.503 |
| 1-Octyne | 1.416 |
| Propargyl acetate | 1.419 |
| Diphenylacetylene | 1.608 |

### Fourier Transform Infrared Spectroscopy

ATR-FTIR (Thermo Scientific Nicolet IS FTIR with iTX smart accessory spectrometer) or FTIR (Thermo Scientific Nicolet 6700 FTIR spectrometer) were employed to monitor the dithiolanes or alkyne monomers concentrations before and after (static measurements, 64 scans, 2 resolution) or during polymerization (real-time measurements, 2 scans, 4 resolution). Samples were irradiated using an EXFO Acticure A 4000 high-pressure mercury vapor short arc lamp with a 400-500 nm bandpass filter insert. Light intensity was adjusted to the desired value (40 mW cm⁻² for all the experiments conducted during this research) using a radiometer from Thorlabs, model PM100D at 405 nm wavelength. The ATR-FTIR spectrometer with ITX accessory was used to obtain the FTIR spectra of the materials synthesized as well as carried out static and real-time measurements for homopolymerization of the 1,2-dithiolanes under study by placing the monomer samples directly over the diamond crystal-covered with glass slide, this arrangement allowed for monitoring of the C—S peak for the dithiolanes 689-660 cm⁻¹ with a timed and defined illumination of 40 mW cm⁻². To follow the copolymerization (1,2-dithiolane. alkynes) in real-time, optically thin samples were prepared between two salts (KBr) plates and irradiated from the top using a horizontal device inserted in the FTIR spectrometer. This setup has been described previously in the literature. Real-time spectra at a resolution of 4 cm⁻¹ and 2 scans were collected.

Terminal alkyne concentrations were determined by integrating the peak at ˜3280 cm⁻¹ corresponding to C═C—H stretching or the C≡C peak at ˜2100 cm⁻¹ for the internal alkyne. Eqn (2) was used to calculate the percentage of conversion (C); A₀ is the area under the peak associated with the unconsumed functional group (689-660 cm⁻¹ for dithiolanes, 3552-3162 cm⁻¹ for internal alkynes and 2235-2192 for the internal alkyne) and Aₜ is the area under the functional group peak at time “t”.

$$C = ( 1 - \frac{{A}_{o}}{{A}_{t}} ) \times 100 \qquad ( 2 )$$

### Gas Permeation Chromatography (GPC) Size Exclusion Chromatography (SEC)

Molecular weights and molecular weight distribution dispersities (Ð=M_{w}/Mₙ) were determined by size exclusion chromatography (SEC) on a Tosoh EcoSEC system equipped with two columns in series (SuperH4000 and SuperH2500) using refractive index (RI) detector. Chloroform was used as the eluent at a flow rate of 0.35 mL min⁻¹ (40° C.). The SEC calibration was based on linear polystyrene standards.

### Liquid Chromatography-Mass Spectrometry (LC-MS)

Samples were dissolved in dichloromethane at 10 mM. 25 mL samples were injected into Waters™ SYNAPT G2 mass spectrometer by a manually controlled syringe system. The mass spectrometry data were collected under MS mode with positive polarity. All samples were acquired in resolution mode. The capillary voltage was set to 3.0 kV for the sample sprayer. Data were acquired at a scan time of 1 s with a range of 100-1500 m/z. Mass correction was done using Leucine Enkephalin (556.2771 Da) as a reference.

### Film Preparation for Holography

Two-stage photopolymer film samples were prepared by premixing the writing components (Dithiolane-alkyne mixtures) measured a set weight percentage (relative to the entire formulation) with 1% TPO photoinitiator (based on writing monomers concentration) and the difunctional polyol (in a 25 mL vial mixing with vortex until homogeneous. A stoichiometric amount (OH/NCO=1:1) of Desmodur 3900 trifunctional isocyante was added to the vial and stirred, then the mixture was vacuumed to remove air bubbles created during the mixing procedure. The mixture was sandwiched between glass slides with a spacer of 30 μm and placed in the oven at 40° C. for 18 hours to form a polyurethane film with the writing monomer on it.

### Holography Recording

The holography recording was performed using the two-beam interference setup shown in FIG. 3 was used to record transmission volume Bragg holograms. A spatially filtered laser diode (λ_{record}=405 nm) was used to record the holographic gratings (Ondax, 40 mW). Each recording beam has a circular diameter of d_{record}=9.5 mm and a slowly varying transverse intensity profile. The two recording beams were power matched for a total optical intensity of 211.6 μW/cm² at the plane of the sample. The beams were incident upon the media sample at an external recording half-angle of θ=18.2° to produce an unslanted, sinusoidal interference pattern with a fringe spacing of Λ˜1 μm. A probe laser (λ_{read}=635 nm) was aligned to the center of the exposure area at the Bragg-matching angle to nondestructively monitor holographic fringe formation during the exposure (Thorlabs PL202, 1 mW. The transmitted and diffracted probe beams are monitored with power meters (Newport 2936-R and 918D-UV ×2). The grating-development time dynamics are measured first, then the hologram is rotated from −8° to 8° using a rotary stage (Newport URS100BPP) to acquire the Bragg-angle detuning response. The diffraction efficiency (DE) of each hologram was calculated by taking the quotient of the measured diffracted power to the total power. This can be written as

$$DE = \frac{{I}_{diff}}{( {I}_{diff} + {I}_{trans} )} ,$$

Where I_{diff} and Iₜᵣₐₙₛ are the measured optical intensities of the diffracted and transmitted beams, respectively. The Bragg-angle detuning response was fitted to Kogelnik's coupled wave theory (CITE) to obtain a peak-to-mean index modulation amplitude (Δn) and media thickness (L).

### Birefringence Measurements

The in-plane (η_{TE}) and out-of-plane (η_{TM}) refractive indexes of the two-stage photopolymer films were carried out using a prism coupler (Metricon, model PC-2000) equipped with a He—Ne laser (wavelength: 633 nm) and a half-waveplate in the light path. The in-plane/out-of-plane δn values were estimated as a difference between η_{TE} and η_{TM}, and the average n values were calculated according to the equation δη=|η_{TE}−η_{TM}|.

### Example 1—Chemical Synthesis

### 4-methyl-1,2-dithiolane-4-carboxylic acid (Me-AspAc)

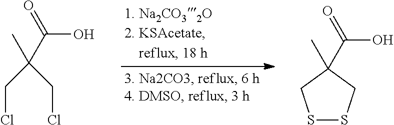

To 13.14 g (0.0768 mol) of 3,3′-dichloropivalic acid and 300 mL of distilled water were placed in a 500 mL round-bottomed flask equipped with a condenser and a dropping funnel. To continue, 8.55 g (0.0868 mol, 1.05 eq) of sodium carbonate was added slowly; once the addition was finished, 17.55 g (0.1536 mol) of potassium thioacetate dissolved in 70 mL of distilled water was added dropwise, and the reaction mixture was brought to reflux for 18 hours. The reaction was allowed to reach room temperature, and 25.62 g (0.2418 mol) of sodium carbonate was added slowly, then it was allowed to reflux for 6 hours. After the disappearance of the starting material, 14 mL of DMSO was added, followed by refluxing for another 3 hours. The reaction mixture was allowed to reach room temperature and acidified with cold HCl (100 mL) in an iced bath. A yellow precipitate is obtained, filtered, washed with iced water, and dried on air. The yellow solid was recrystallized from a methylene chloride/hexane mixture to obtain 8.74 g of a yellow solid. Yield: 57%. ¹H NMR (400 MHz, CD₃OD): δ 3.66 (d, J=12 Hz, 2H, CH₂), 2.96 (d, J=12 Hz, 2H, CH₂), 1.48 (s, 3H, CH₃). ¹³C NMR (101 MHz, CD₃OD): δ 176.58 (CO), 57.22 (C), 47.39 (CH₂), 23.06 (CH₃).

### Methyl 5-(1,2-dithiolan-3-yl)pentanoate (LipOMe)

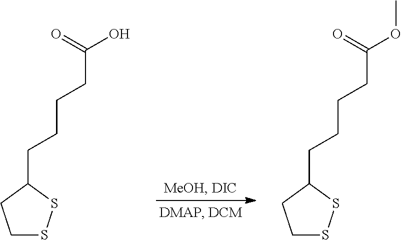

To 20.00 g (96.9 mmol; 1.0 eq) of DL-α-lipoic acid was dissolved in anhydrous dichloromethane (300 mL) under a nitrogen atmosphere. Then 5.92 g (48.5 mmol; 0.5 eq) of 4-N,N′-dimethylamino) pyridine were added slowly to the solution followed by N, N-diisopropyl carbodiimide (DIC) (14.64 g; 116 mmol; 1.2 eq). The reaction mixture was stirred 10 minutes at room temperature and cooled using ice bath. To continue, 31.00 g; 970 mmol, 10 eq) of methanol was added dropwise using an addition funnel. The reaction mixture was stirred at room temperature overnight. The solid by-product was filtered using a celite pad. The organic layer is washed 2×1 M solution of HCL and 2×with brine and dried over MgSO₄ and filtered. The organic layer was concentrated; material was purified using flash chromatography 80:20 mixture of hexane:ethyl acetate. After solvent evaporation 20.00 g of a yellow, low-viscosity liquid were obtained (yield: 94%). ¹H NMR (400 MHz, CD₂Cl₂) δ 3.67 (s, 3H, OCH₃), 3.61 (m, 1H, (S—CH—C), 3.18 (m, 2H, S—CH₂—CH₂) 2.50 (m, 1H, S—CH₂—CH₂), 2.34 (t, 2H, J=8 Hz, CH₂), 1.94 (m, 1H, S—CH₂—CH₂), 1.70 (m, 4H, CH₂), 1.49 (m, 2H, CH₂). ¹³C NMR (101 MHz, CD₂Cl₂) δ 173.69 (CO), 56.41(S—CH—C), 51.27(CH₃), 40.22, 38.50 (S—C≡CH₂), 34.57(S—CH₂—C), 33.72(CH₂), 30.07(CH₂), 28.71(CH₂), 24.66 (CH₂).

### Methyl 4-methyl-1,2-dithiolane-4-carboxylate (Me-AspOMe)

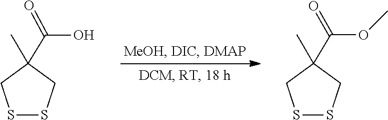

To 10.00 g (60.9 mmol; 1.0 eq) of Methyl Asparagusic acid (synthesis 2) was dissolved in anhydrous dichloromethane (150 mL) under a nitrogen atmosphere. Then 0.372 g (3.0 mmol; 0.05 eq) of 4-N,N′-dimethylamino) pyridine were added slowly to the solution followed by N,N-diisopropylcarbodiimide (DIC) (9.22 g; 73 mmol; 1.2 eq). The reaction mixture was stirred 10 minutes at room temperature and cooled using an ice bath. To continue, 19.51 g; 608 mmol, 10 eq) of methanol was added dropwise using an addition funnel. The reaction mixture was stirred at room temperature overnight. The solid by-product was filtered using a celite pad. The organic layer is washed with 2×1 M solution of HCL and 2× with brine, dried over MgSO₄, and filtered. The organic layer was concentrated; the material was purified using flash chromatography 80:20 mixture of hexane:ethyl acetate. After solvent evaporation 20 g of a yellow, low-viscosity liquid were obtained (yield: 73%). ¹H NMR (400 MHz, CD₂Cl₂) δ 3.76 (s, 3H, OCH₃), 3.68 (d, J=10.4 Hz, 2H, SCH₂), 2.96 (d, J=10.4 Hz, 2H, SCH₂), 1.49 (s, 3H, CH₃). ¹³C NMR (101 MHz, CD₂Cl₂) δ 174.76 (CO), 57.55 ((CH₂)₂—C—CH₃), 51.92 (OCH₃), 47.84((CH₂)₂), 24.02 ((CH₂)₂—C—CH₃).

### Example 2: Development of Refractive Polymers

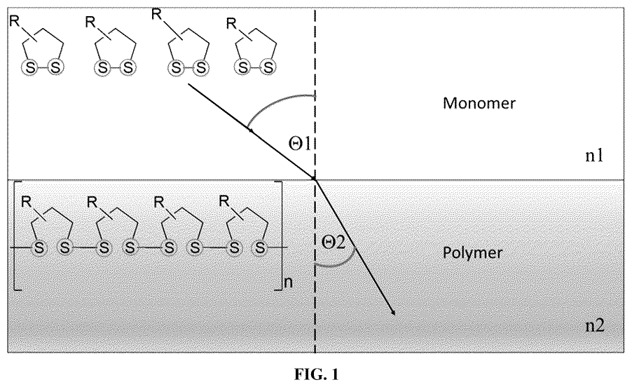

A particular class of sulfur-containing molecules 1,2-dithiolanes, which contain a saturated five-membered disulfide ring, shown remarkable potential for the development of intrinsically high refractive index polymers with low volumetric shrinkage, due to its ability to participate in a variety of radical and ionic ring opening reactions yielding thiolate or sulfur-centered radicals each of which can initiate ring opening oligomerization or polymerization with another cyclic disulfide producing disulfide-rich backbone of poly(dithiolane). FIG. 1 shows sulfur rich backbone polymers and their potential properties.

Among the 1,2-dithiolanes molecules, lipoic and asparagusic acid (natural occurring molecules) are perhaps the best-known members of this group. The ring opening reaction of 1,2 dithiolanes occur via both thermally and light induced even in the absence of initiator.

Herein, the feasibility of 5-membered cyclic disulfides to copolymerize with various alkynes affording polymers with disulfide-rich backbone is demonstrated. Photopolymerization kinetics and comparison of the curing rates of various compositions and stoichiometric ratios is investigated to develop valuable optical materials. Research concerning refractive index of the 1,2-dithiolane monomers and their polymers, or their evaluation as optical materials have not been addressed until now.

Copolymerization of LipOMe with Alkynes

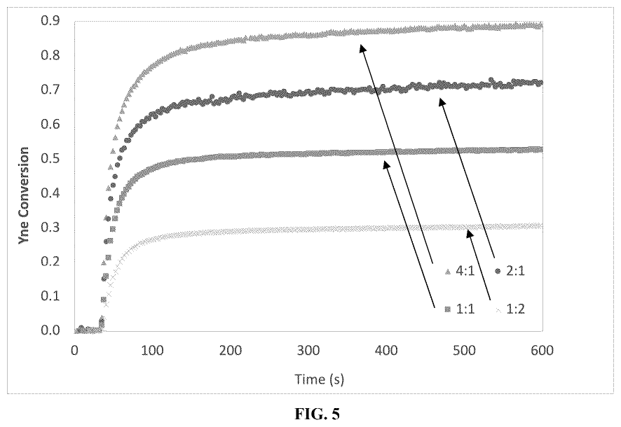

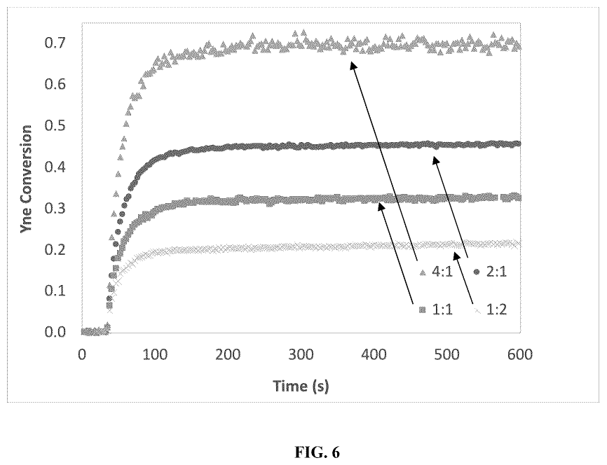

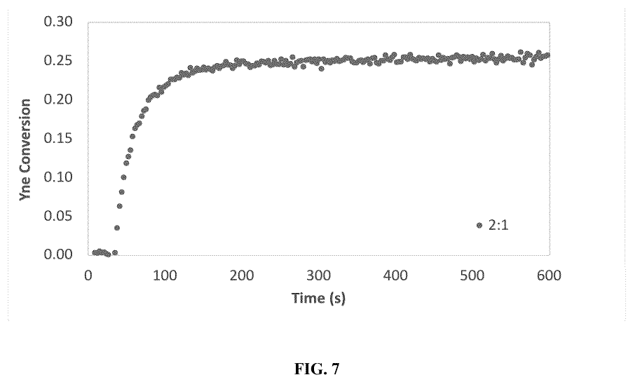

Having demonstrated the effect of the homopolymerization of 1,2-dithiolanes on polymer characteristics and optical properties of their polymers, copolymerization with alkynes was next to be explored. The alkynes composition during copolymerization with LipOMe at various stoichiometric ratios was determined in real-time by FT-IR using a horizontal transmission accessory designed to enable mounting of samples in a horizontal orientation for FTIR measurements, the peak corresponding to —C—H stretching absorption centered at ˜3280 cm⁻¹ was chosen to follow the consumption of alkynes during polymerization, as the peak associated with C≡C at 2100 cm⁻¹ which is the most prominent band of the alkynes IR spectrum appeared as a week band. The band is weak because the triple bond is not very polar. Unfortunately, the ring-opening reaction of the 1,2-dithiolane ring couldn't be simultaneously monitored as the corresponding peak areas for C—S overlap with absorption peaks of components in the reaction mixtures. FIG. 5, FIG. 6, and FIG. 7 show plots of conversion versus time for the different compositions and ratios, final alkyne conversion, and rates of polymerization. It can be observed that the rapid consumption of alkynes, occurs in the first seconds of reaction. Moreover, a higher degree of alkyne conversions is observed at higher LipOMe concentrations (4:1>2:1>1:1>1:2) for all the alkynes under study.

Similar to observations on thiol-yne systems, during the copolymerization of LipOMe and the alkynes under study, the vinyl sulfide intermediate species was observed via FT-IR while ¹H NMR showed an indistinguishable peak at 6.0 ppm which discrepancy may be related to peak broadening in NMR spectra of macromolecules. GPC results of the polymerized comonomer mixtures can be observed in Table 2. Interestingly, the polymers obtained through this route are characterized by narrow dispersity Ð<1.4. The index of refraction for 1,2-dithiolanes and alkynes mixtures before and after polymerization are summarized also in Table 3.

TABLE 2
Compositions, monomer ratios, alkynes final conversions
by FTIR (verified by ¹H NMR for terminal alkynes),
polymerization rates from Conversion versus time plots obtained by
FTIR, and LipOMe conversion obtained by ¹H NMR
(representative samples). All samples were irradiated between
KBr discs with a light intensity of 40 mW/cm²,
with 450-500 nm filtered light for 600 s.

| | | % Yne | Reaction | % Dithiolane |
|---|---|---|---|---|
| | | Conver- | Rate | Conver- |
| | | sion | (s⁻¹) × | sion |
| Composition | Ratio | (FTIR) | 10⁻³ | (¹H NMR) |
| LipOMe:phenylacetylene | 4:1 | 95 ± 1 | 11 | 91 ± 2 |
| LipOMe:phenylacetylene | 2:1 | 77 ± 1 | 09 | 90 ± 2 |
| LipOMe:phenylacetylene | 1:1 | 55 ± 1 | 06 | 89 ± 2 |
| LipOMe:phenylacetylene | 1:2 | 32 ± 1 | 03 | 92 ± 2 |
| LipOMe:1-octyne | 4:1 | 71 ± 1 | 08 | / |
| LipOMe:1-octyne | 2:1 | 62 ± 1 | 05 | 91 ± 2 |
| LipOMe:1-octyne | 1:1 | 36 ± 1 | 04 | / |
| LipOMe:1-octyne | 1:2 | 24 ± 1 | 03 | / |
| LipOMe:propargyl | 4:1 | 46 ± 3 | 05 | / |
| acetate | | | | |
| LipOMe:propargyl | 2:1 | 40 ± 1 | 04 | 77 |
| acetate | | | | |
| LipOMe:propargyl | 1:1 | 21 ± 3 | 03 | / |
| acetate | | | | |
| LipOMe:propargyl | 1:2 | 17 ± 3 | 02 | / |
| acetate | | | | |
| LipOMe:diphenylacetylene | 4:1 | 56 ± 2 | 13 | / |
| LipOMe:diphenylacetylene | 2:1 | 38 ± 1 | 10 | 85 |
| LipOMe:diphenylacetylene | 1:1 | 53 ± 3 | 50 | / |
| LipOMe:diphenylacetylene | 1:2 | 52 ± 2 | 61 | / |

TABLE 3
Macromolecular characteristics and index of refraction
for the polymers synthesized in this disclosure.

| | | Mn | | nD | nD | |
|---|---|---|---|---|---|---|
| Composition | Ratio | (kDa) | Ð | Resin | Polymer | Δn |
| LipOMe:Phenylacetylene | 4:1 | 16.4 | 1.28 | 1.50852 | 1.55857 | 0.05 |
| LipOMe:Phenylacetylene | 2:1 | 18.7 | 1.33 | 1.50638 | 1.54671 | 0.04 |
| LipOMe:Phenylacetylene | 1:1 | 20.0 | 1.40 | 1.50589 | 1.54489 | 0.04 |
| LipOMe:Phenylacetylene | 1:2 | 15.3 | 1.30 | 1.50295 | 1.51927 | 0.02 |
| LipOMe:1-Octyne | 4:1 | 10.5 | 1.29 | 1.51678 | 1.52791 | 0.01 |
| LipOMe:1-Octyne | 2:1 | 15.3 | 1.23 | 1.50109 | 1.51709 | 0.01 |
| LipOMe:1-Octyne | 1:1 | 11.2 | 1.27 | 1.49138 | 1.50038 | 0.01 |
| LipOMe:1-Octyne | 1:2 | 10.5 | 1.27 | 1.46600 | 1.477266 | 0.01 |
| LipOMe:Propargyl Acetate | 2:1 | 19.6 | 1.29 | 1.50636 | 1.511155 | 0.005 |
| LipOMe:Diphenylacetylene | 2:1 | 20.1 | 1.18 | 1.56783 | 1.57771 | 0.01 |

Copolymerization of Me-AspOMe with Alkynes

Photopolymerization reactions of Me-AspOMe with alkynes were also studied using the FT-IR technique. Thus, the FT-TR spectra for regions between 3500 and 2000 cm⁻¹ (FIG. 12) for a 2:1 mixture of Me-AspOMe:Phenylacetylene showed the decrease of the area peak at 3281 cm⁻¹ and 2110 cm⁻¹ corresponding to ≡C—H and C≡C stretching upon polymerization. Foreseen was the observation of the appearance of a new peak at 1530 cm⁻¹, a region normally associated with C═C stretching. It is important to note that the peak mentioned around 1530 cm⁻¹, was observed in the copolymerization of LipOMe with alkynes. However, the peak was not visible in the ¹H NMR spectra, which discrepancy may be related to peak broadening in NMR spectra of macromolecules.

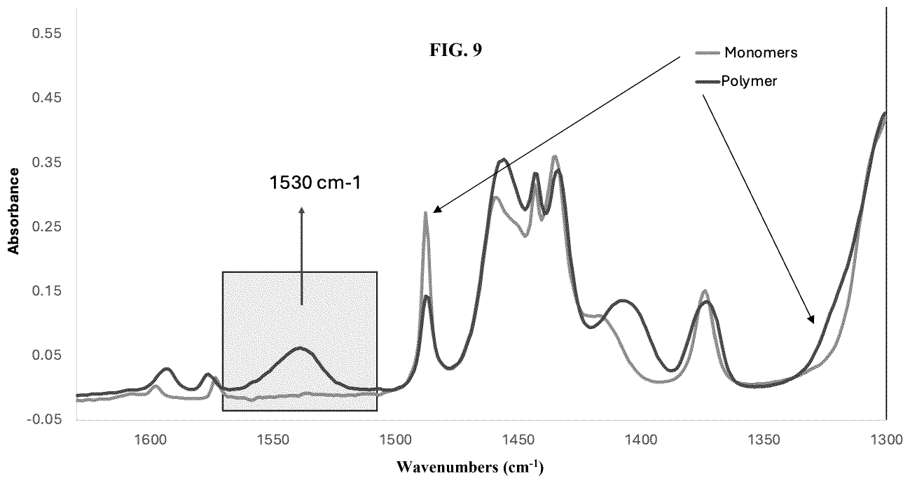

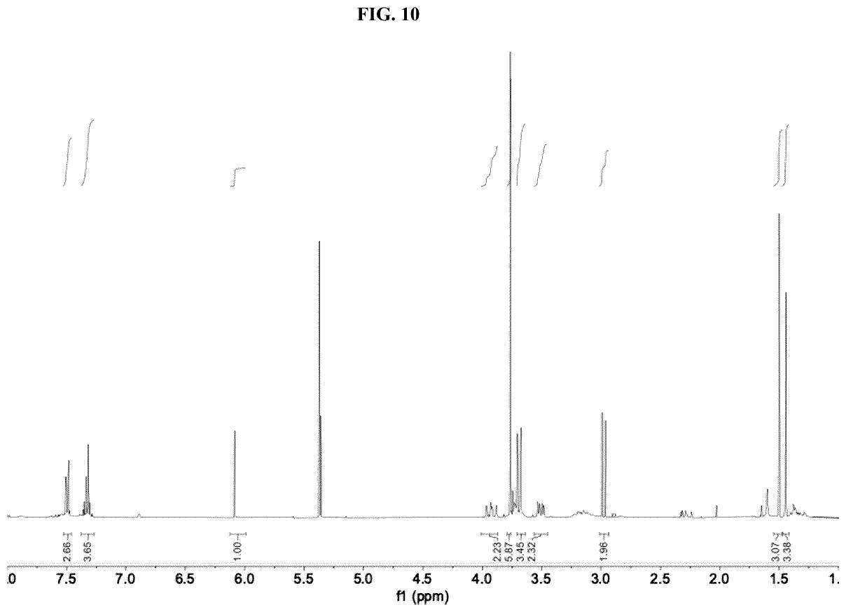

The photopolymerization of Me-AspOMe with alkynes highlighted large differences in reactivity between the two 1,2-dithiolanes under study (Table 4). Table 4 also shows GPC results for polymerization of Me-AspOMe:phenylacetylene in a 2:1 composition ratio. Surprisingly and unexpectedly a low molecular weight for the Me-AspOMe and phenylacetylene polymer was observed despite the high level of conversion and change in the refractive index from resin to polymer reached of 0.06. ¹H NMR spectra for the crude product mixture obtained when photopolymerized Me-AspOMe:phenylacetylene (2:1 ratio) showed clear evidence of the presence of the vinyl sulfide intermediate revealing a strong peak around 6.0 ppm (FIG. 10).

To further understand the course of the photopolymerization reaction for Me-AspOMe:phenylacetylene (2:1 ratio), the reaction products were separated using a Biotage automatic chromatography column with Hexane:Ethyl Acetate (80:20) as eluent, two fractions were obtained and analyzed by ¹H and ¹³C NMR. ¹H NMR in CDCl₃ of the first fraction isolated aside from the presence of unreacted Me-AspOMe, a singlet centered at 6.09 ppm, the region of ¹H NMR spectra associated with vinylic (C═CH) protons, indicating the potential addition of one dithiolane to one yne. Furthermore, the presence of 5 aromatic protons in the range of 7.51-7.29 ppm, signals at 3.97-3.92 (m), 3.74 (s), 3.54-3.48 (m), and 1.44(s) together with the corresponding ¹³C NMR are fully consistent with the mono-addition product (intramolecular cyclization) and in agreement with the corresponding average molecular weight (M_{w}=281) found during the GPC analysis, which led to believe the presence of the vinyl sulfide (methyl 6-methyl-2-phenyl-6,7-dihydro-5H-1,4-dithiepine-6-carboxylate) with the chemical structure shown on FIG. 11. The structure was verified by LC-MS with obtained m/z values of 280.06 (41.6%), 281.07 (M*, 100%), 282.07 (20.8%), 283.06 (10.4%), 283.14 (3.2%), which matches the expected values for the chemical structure in FIG. 11. Without being bound by theory, one potential mechanism for the formation of the dithiepine in FIG. 13 is shown in FIG. 12.

The ¹H NMR of the second fraction is quite complex and showed broad signals as expected for polymeric structures. Peaks found between 8.0-7.5 ppm corroborated the presence of phenyl groups while signals at 3.7-3.5 ppm, 3.3-3.0 ppm, and 1.5-1.2 ppm ranges correspond to CH₂ and CH₃ groups associated with the opening of the dithiolane ring. The obtained integration of phenyl groups to methyl groups indicates a polymeric structure with one phenyl group per two disulfide groups and a molecular weight of ˜3 kDa.

TABLE 4
Summary of yne conversion percentage, n_{D} resin value, n_{D} polymer value, and Δn.

| | | Yne | | | |
|---|---|---|---|---|---|
| | | Conversion | n_{D} | n_{D} | |
| ENTRY | Composition | (%) | Resin | Polymer | Δn |
| 11 | Me-AspOMe/Phenylacetylene 2:1 | 87 ± 3 | 1.527657 | 1.583031 | 0.06 |
| 12 | Me-AspOMe/1-Octyne 2:1 | 0 | — | — | — |

TABLE 5
Summary of Yne polymer experimental results.

| | | Area | | | M_{w}/ |
|---|---|---|---|---|---|
| ENTRY | Composition | (%) | Mₙ | M_{w} | Mₙ |
| 13 | Me-AspOMe:Phenylacetylene 2:1 | 38.3 | 3040 | 4372 | 1.43 |
| | | 43.6 | 281 | 284 | 1.01 |

### Film Preparation for Holography

Two-stage photopolymer film samples were prepared by premixing in a vial the writing component, LipOMe, measured at a set weight percentage (30 wt %) (relative to the entire formulation) and 10 wt % of 4-ethyl benzyl alcohol (yne component of the writing system) for a dithiolane:yne ratio of 2:1, in a matrix consisting of a mixture of tetrafunctional polyols (PE 15/4) in 13 wt % and polyol 2000 (in a 25 mL vial) in 22 wt % and with 1% TPO photoinitiator (based on writing monomers concentration), after mixing with vortex until homogeneous a stoichiometric amount (OH:NCO=1:1) of Desmodur N3900 (TNCO) trifunctional isocyanate (20 wt %) was added into the vial and stirred until fully homogeneous, to continue the mixture was vacuumed to remove air bubbles created during the mixing procedure. The mixture was sandwiched between glass slides with a spacer of 30 m and placed in the oven at 40° C. for 18 hours to form a polyurethane film with the writing system on it.

### Holographic Recording

In various embodiments, the performance of the new 1,2-dithiolane-yne chemistry in a two-stage holography system.

### Test Configuration 1

The photopolymer material consisted of −30 mm thickness film sandwiched between glass slides containing a low refractive index polyurethane matrix of Polyol2000/TNCO (R.I=1.4778), alkyne pendants groups of 4-ethynyl benzyl alcohol (10 wt % of total matrix weight), 30 wt % (based on total weight) of LipOMe and 1 wt % (based on monomer weight) of TPO as radical photoinitiator. Single transmission holograms were recorded into the material using a two-beam interference setup (FIG. 3). To summarize, a spatially filtered laser diode (1=405 nm) was used to record the holographic gratings (Ondax, 40 mW). Two recording beams were power matched for a total optical intensity of 211.6 μW/cm² at the plane of the sample. The beams were incident upon the media sample at an external recording half-angle of 0=18.2° to produce an unslanted, sinusoidal interference pattern with a fringe spacing of A 1 m. A probe laser (λ_{read}=635 nm) was aligned to the center of the exposure area at the Bragg-matching angle to nondestructively monitor holographic fringe formation during the exposure (Thorlabs PL202, 1 mW). The diffraction efficiency (DE) of each hologram was calculated by taking the quotient of the measured diffracted power to the total power by the following equation:

$$DE = \frac{{I}_{diff}}{( {I}_{diff} + {I}_{trans} )} ,$$

where I_{diff} and Iₜᵣₐₙₛ are the measured optical intensities of the diffracted and transmitted beams, respectively. The Bragg-angle detuning response was fitted to Kogelnik's coupled wave theory to obtain a peak-to-mean index modulation amplitude (Δn) and media thickness (L). FIG. 13A and FIG. 13B show a representative example of a hologram and the angular scan with fits to the Kogelnik coupled wave theory obtained. The good agreement of the fit, R²=0.995, indicates minimal fringe distortion or other non-idealities. The Peak-to-mean value (Δn) of 0.006 obtained at 405 nm (I=3.7 mW/cm²) is comparable with the value described by Hata et al. of 0.008 utilizing silica nanoparticle-polymer composites based on thiol-yne photopolymers. More recently, Bowman and coworkers recorded transmission holograms in a thiol-yne formulation which exhibited Δn of 0.018 (405 nm, I=16 mW/cm²), however, diffusional blurring induced by the incomplete conversion of the writing monomers reduced the overall index contrast and remains a limitation in achieving high index modulation (DE). FIG. 13C corresponds to the diffraction efficiency (DE) throughout the recording media, which reached a value approaching 80%, indicating a high-performing holographic grating. No signal decay was observed after exposure indicating stable holograms.

### Test Configuration 2

The holographic recording was performed using the two-beam interference setup shown in FIG. 3 to pattern unslanted holographic volume phase transmission gratings. A spatially filtered laser diode (Ondax CP-405-PLR-40, λ_{record}=405 nm) was used to record the holographic gratings. Each recording beam had a circular diameter of d_{record}=9.5 mm and a slowly varying transverse intensity profile. The two recording beams were power matched for a total optical intensity of 3.7 mW cm⁻² at the plane of the sample. The s-polarized beams were incident upon the media sample at an external recording half-angle of θ=18.2° to produce an unslanted, sinusoidal interference pattern with a fringe spacing of Λ≈650 nm. A probe laser (λ_{read}=635 nm) was aligned to the center of the exposure area at the Bragg-matching angle to nondestructively monitor holographic fringe formation during the exposure (Thorlabs PL202, 1 mW). The probe beam has a circular diameter of d_{read}=0.5 mm. The transmitted and diffracted probe beams were monitored with power meters (Newport 2936-R and 918D-UV ×2). The grating-development time dynamics were measured during the exposure by pre-aligning the read beam to the Bragg condition of the grating and monitoring diffraction efficiency throughout the grating development. Then, the hologram is rotated 12 degrees about the Bragg angle using a rotary stage (Newport URS100BPP) to acquire the Bragg-angle detuning response. Each hologram's diffraction efficiency (i) was calculated by taking the quotient of the measured diffracted power to the total power.

### Birefringence Measurements

A step forward in further evaluating the optical films was to measure birefringence. Birefringence, which is formally defined as the double refraction of light in a transparent, molecularly ordered material, is manifested by the existence of orientation-dependent differences in refractive index and was evaluated by calculating the difference between the in-phase (TE) and out-of-phase (TM) components at 636.6 nm. Table 6 displays the values obtained for the TE and TM polarized samples used to determine the birefringence values δη=|η_{TE}−η_{TM}|.

The s-polarized (n_{TE}) and p-polarized (n_{TM}) refractive indices of the two-stage photopolymer films were measured using a prism coupler (Metricon, model PC-2000) equipped with a He—Ne laser (λ=636 nm) with polarization modulated by a half-waveplate in the light path. The 6n values were calculated as a difference between n_{TE} and n_{TM} according to the following equation:

$$δ n = \vert {n}_{TE} - {n}_{TM} \vert .$$

Holograms written with the 1,2-dithiolane-yne system exhibited extremely low values δη=7.0×10⁻⁴±0.0002, indicating that the cured media was essentially non-birefringent at this wavelength, meaning that the index of refraction is equal in all directions throughout the film indicating that the material is optically isotropic.

TABLE 6
Birefringence measurements made before and after flood
cure to full conversion at λ = 636.6 nm using
Metricon model 2010/M Prisma Coupler.

| Optical Cure | η_{TE} | η_{TM} | δη |
|---|---|---|---|
| Pre | 1.5116 ± 0.0007 | 1.5116 | 0.0000 |
| Post | 1.5132 ± 0.0008 | 1.5125 | 6.9667 × 10⁻⁴ |

The terms and expressions employed herein are used as terms of description and not of limitation, and there is no intention in the use of such terms and expressions of excluding any equivalents of the features shown and described or portions thereof, but it is recognized that various modifications are possible within the scope of the embodiments of the present application. Thus, it should be understood that although the present application describes specific embodiments and optional features, modification and variation of the compositions, methods, and concepts herein disclosed may be resorted to by those of ordinary skill in the art, and that such modifications and variations are considered to be within the scope of embodiments of the present application.

### ENUMERATED EMBODIMENTS

The following enumerated embodiments are provided, the numbering of which is not to be construed as designating levels of importance:

Embodiment 1 provides a method of generating a polymer, the method comprising:
contacting a compound of Formula (I):

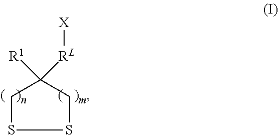

wherein
   m and n are integers and the sum of m and n is 2, 3, or 4;
   R¹ is H or C₁-C₆ alkyl;
   R^{L} is —(CH₂)ₚ—, —(OCH₂—CH₂)ₚ—, —(CHR^{L1})ₘ₁—O—(CHR^{L2}—CHR^{L}—O)ₘ₂—(CHR^{L4})ₘ₃—C(O)—, —C(O)—(CHR^{L4})ₘ₃—(O—CHR^{L3}—CHR^{L2})ₘ₂—O—(CHR^{L1})ₘ₁—, —(CH₂)ₘ₁—Z¹—[(CH₂)ₘ₄Z²]ₘ₂—(CH₂)ₘ₃—Z³—, or
      —Z³—(CH₂)ₘ₃—[Z²(CH₂)ₘ₄]ₘ₂—Z¹—(CH₂)ₘ₁—;
   m1, m2, and m3 are each independently an integer from 0 to 20;
   m4 is an integer from 0 to 4;
   p is an integer from 1 to 7;
   r is an integer from 1 to 7;
   R^{Z} is independently at each occurrence H or C₁-C₆ alkyl;
   Z¹, Z², and Z³ are each independently absent (a bond), —O—, —S—, —NR^{L5}—, —C(O)—NR^{L5}—, or —NR^{L5}—C(O)—, wherein each R^{L5} is independently selected from the group consisting of hydrogen, C₁-C₆ alkyl, C₆-C₁₀ aryl, C₅-C₁₀ heteroaryl, C₃-C₈ cycloalkyl, and C₃-C₈ cycloheteroalkyl, each of which is optionally substituted by 1 to 3 groups selected from the group consisting of halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)₁₋₂R^{Z}.
   R^{L1}, R^{L2}, R^{L3}, and R^{L4} are each independently selected from the group consisting of hydrogen, C₆-C₁₀ aryl, C₁-C₆ alkyl, C₃-C₈ cycloalkyl, C₅-C₁₀ heteroaryl, and C₃-C₈ cycloheteroalkyl, each of which are optionally substituted by 1 to 3 groups selected from the group consisting of halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, —S(O)₁₋₂R^{Z};
   X is —C(R^{X})₃, —OR^{X}, N(R^{X})₂, —S—R^{X}, —S—S—R^{X}, —CH(SR^{X})₂, —C(O)—R^{X}, —C(O)—OR^{X}, —C(O)N(R^{X})₂, —C₆₋₁₀ aryl optionally substituted by 1 to 6 R^{X} groups, —NH—C(O)—R^{X}, or —NH—C(O)—N(R^{X})₂,wherein each occurrence of R^{X} is independently selected from the group consisting of H, halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)₁₋₂R^{Z};
      with an alkyne of Formula (II):

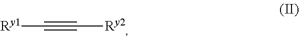

wherein
R^{y1} and R^{y2} are selected from the group consisting of hydrogen, C₆-C₁₀ aryl, C₁-C₆ alkyl, C₃-C₈ cycloalkyl, C₅-C₁₀ heteroaryl, and C₃-C₈ cycloheteroalkyl, each of which are optionally substituted by 1 to 3 groups selected from the group consisting of halogen, —CN, —C(O)—R^{Z}, —O—C(O)—R^{Z}, —(CH₂)ᵣC(O)—O—R^{Z}, NR^{Z}R^{Z}, —NO₂, —R^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)₁₋₂R^{Z}, provided that at least one of R^{y1} and R^{y2} is not hydrogen;
or wherein R^{y1} and R^{y2} are fused to form an 8 to 13-membered cycloalkyl ring, which is optionally substituted by 1 to 3 groups selected from the group consisting of halogen, C₆-C₁₀ aryl, C₁-C₆ alkyl, C₃-C₈ cycloalkyl, C₅-C₁₀ heteroaryl, and C₃-C₈ cycloheteroalkyl, each of which are optionally substituted by 1 to 3 groups selected from the group consisting of H, halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)—₂R^{Z}.

Embodiment 2 provides the method of embodiment 1, wherein m is 0 or 1 and n is 0 or 1.

Embodiment 3 provides the method of any one of embodiments 1-2, wherein R^{L} is —(CH₂)ₚ—, wherein p is an integer from 1 to 7.

Embodiment 4 provides the method of any one of embodiments 1-3, wherein the compound of Formula (I) is:

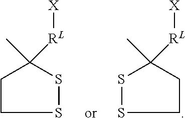

Embodiment 5 provides the method of any one of embodiments 1-4, wherein R¹ is methyl.

Embodiment 6 provides the method of any one of embodiments 1-5, wherein the compound of Formula (I) is:

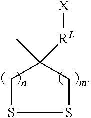

Embodiment 7 provides the method of any one of embodiments 1-6, wherein the compound of Formula (I) is:

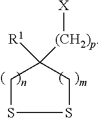

Embodiment 8 provides the method of any one of embodiments 1-7, wherein the compound of Formula (I) is:

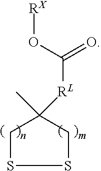

Embodiment 9 provides the method of any one of embodiments 1-8, wherein the compound of Formula (I) is selected from the group consisting of:

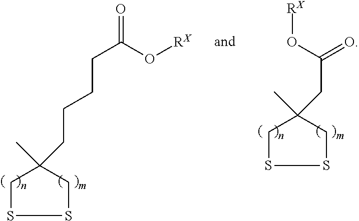

Embodiment 10 provides the method of any one of embodiments 1-9, wherein the compound of Formula (I) is

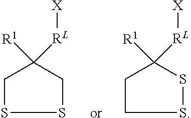

Embodiment 11 provides the method of any one of embodiments 1-10, wherein the compound of Formula (I) is selected from the group consisting of:

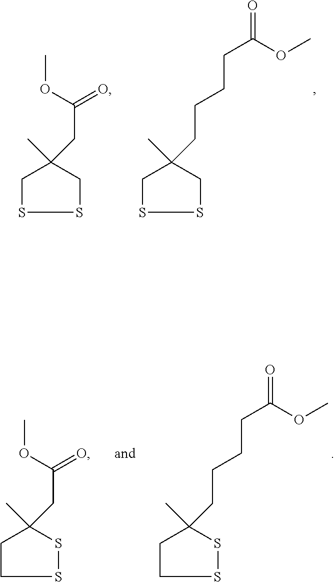

Embodiment 12 provides the method of any one of embodiments 1-11, wherein X is selected from the group consisting of:

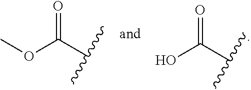

Embodiment 13 provides the method of any one of embodiments 1-12, wherein R^{y2} is H.

Embodiment 14 provides the method of any one of embodiments 1-13, wherein R^{y1} and R^{y2} are each independently selected from the group consisting of hydrogen, phenyl, methyl, and —(CH₂)ᵣC(O)—O—R^{Z}, wherein R^{Z} is C₁-C₆ alkyl.

Embodiment 15 provides the method of any one of embodiments 1-14, wherein the alkyne of Formula (II) is selected from the group consisting of phenylacetylene, 1-octyne, propargyl acetate, methyl propargyl ether, cyclooctyne, ethyl propiolate, methyl propargylamine, 2-octyne, dimethylacetylenedicarboxylate, 1,9-decadiyne, ethyl phenylpropiolate, and diphenylacetylene.

Embodiment 16 provides the method of any one of embodiments 1-15, wherein the polymer further comprises a compound of Formula (III):

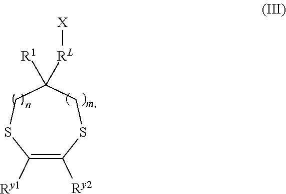

wherein the compound of Formula (III) is present in an amount of about 0.001 to about 20% (w/w) relative to the weight of the polymer.

Embodiment 17 provides the method of any one of embodiments 1-16, wherein the contacting further comprises exposing the compound of Formula (I) to electromagnetic radiation or thermal radiation.

Embodiment 18 provides the method of any one of embodiments 1-17, wherein the electromagnetic radiation is microwave radiation.

Embodiment 19 provides a polymer composition comprising the reaction product of a compound of Formula (I) and a compound of Formula (II):
wherein the compound of Formula (I) has the structure:

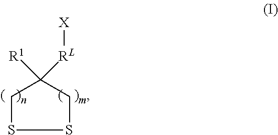

wherein
   m and n are integers and the sum of m and n is 2, 3, or 4;
   R¹ is H or C₁-C₆ alkyl;
   R^{L} is —(CH₂)ₚ—, —(OCH₂—CH₂)ₚ—, —(CHR^{L1})ₘ₁—O—(CHR^{L2}—CHR^{L3}—O)ₘ₂—(CHR^{L4})ₘ₃—C(O)—, —C(O)—(CHR^{L4})ₘ₃—(O—CHR^{L3}—CHR^{L2})ₘ₂—O—(CHR^{L1})ₘ₁—, —(CH₂)ₘ₁—Z¹—[(CH₂)ₘ₄Z²]ₘ₂—(CH₂)ₘ₃—Z³—, or
      —Z³—(CH₂)ₘ₃—[Z²(CH₂)ₘ₄]ₘ₂—Z¹—(CH₂)ₘ₁—;
   m1, m2, and m3 are each independently an integer from 0 to 20;
   m4 is an integer from 0 to 4;
   p is an integer from 1 to 7;
   r is an integer from 1 to 7;
   R^{Z} is independently at each occurrence H or C₁-C₆ alkyl;
   Z¹, Z², and Z³ are each independently absent (a bond), —O—, —S—, —NR^{L5}—, —C(O)—NR^{L5}—, or —NR^{L5}—C(O)—, wherein each R^{L5} is independently selected from the group consisting of hydrogen, C₁-C₆ alkyl, C₆-C₁₀ aryl, C₅-C₁₀ heteroaryl, C₃-C₈ cycloalkyl, and C₃-C₈ cycloheteroalkyl, each of which is optionally substituted by 1 to 3 groups selected from the group consisting of halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)R^{Z}, —C(O)NR^{Z}R^{Z}, —SO₃R^{Z}, —SR^{Z}, and —S(O)₁₋₂R^{Z}.
   R^{L1}, R^{L2}, R^{L3}, and R^{L4} are each independently selected from the group consisting of hydrogen, C₆-C₁₀ aryl, C₁-C₆ alkyl, C₃-C₈ cycloalkyl, C₅-C₁₀ heteroaryl, and C₃-C₈ cycloheteroalkyl, each of which are optionally substituted by 1 to 3 groups selected from the group consisting of halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, —S(O)₁₋₂R^{Z};
   X is —C(R^{X})₃, —OR^{X}, N(R^{X})₂, —S—R^{X}, —S—S—R^{X}, —CH(SR^{X})₂, —C(O)—R^{X}, —C(O)—OR^{X}, —C(O)N(R^{X})₂, —C₆₋₁₀ aryl optionally substituted by 1 to 6 R^{X} groups, —NH—C(O)—R^{X}, or —NH—C(O)—N(R^{X})₂,wherein each occurrence of R^{X} is independently selected from the group consisting of H, halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)₁₋₂R^{Z};
      with the compound of Formula (II) has the structure:

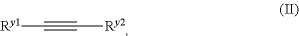

wherein
R^{y1} and R^{y2} are selected from the group consisting of hydrogen, C₆-C₁₀ aryl, C₁-C₆ alkyl, C₃-C₈ cycloalkyl, C₅-C₁₀ heteroaryl, and C₃-C₈ cycloheteroalkyl, each of which are optionally substituted by 1 to 3 groups selected from the group consisting of halogen, —CN, —C(O)—R^{Z}, —O—C(O)—R^{Z}, —(CH₂)ᵣC(O)—O—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)₁₋₂R^{Z}, provided that at least one of R^{y1} and R^{y2} is not hydrogen;
   or wherein R^{y1} and R^{y2} are fused to form an 8 to 13-membered cycloalkyl ring, which is optionally substituted by 1 to 3 groups selected from the group consisting of halogen, C₆-C₁₀ aryl, C₁-C₆ alkyl, C₃-C₈ cycloalkyl, C₅-C₁₀ heteroaryl, and C₃-C₈ cycloheteroalkyl, each of which are optionally substituted by 1 to 3 groups selected from the group consisting of H, halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)—₂R^{Z}.

Embodiment 20 provides the polymer composition of embodiment 19, wherein the polymer composition further comprises about 0.001 to about 20% (w/w) of a compound of Formula (III):

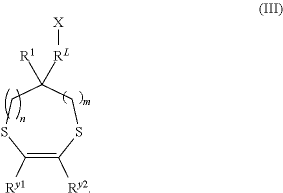

Embodiment 21 provides the polymer composition of any one of embodiments 19-20, wherein the polymer has an average molecular weight from about 1,000 Da to about 100,000 Da.

Embodiment 22 provides the polymer composition of any one of embodiments 19-21, wherein the refractive index is about 1.45 to about 1.60.

Embodiment 23 provides the polymer composition of any one of embodiments 19-22, wherein the polymer is optically isotropic.

Embodiment 24 provides an article of manufacture comprising the composition of any one of embodiments 19-23, wherein the article is a lens, a waveguide, a lithograph, a holograph, a window, a prism, or a mirror, or combinations thereof.

What is claimed is:

1. A method of generating a polymer, the method comprising:
contacting a compound of Formula (I): 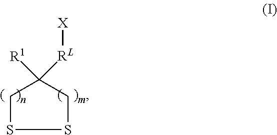
wherein:
m and n are integers and the sum of m and n is 2, 3, or 4;
R¹ is H or C₁-C₆ alkyl;
R^{L} is —(CH₂)ₚ—, —(OCH₂—CH₂)ₚ—, —(CHR^{L1})ₘ₁—O—(CHR^{L2}—CHR^{L3}—O)ₘ₂—(CHR^{L4})ₘ₃—C(O)—, —C(O)—(CHR^{L4})ₘ₃—(O—CHR^{L3}—CHR^{L2})ₘ₂—O—(CHR^{L1})ₘ₁—, —(CH₂)ₘ₁—Z¹—[(CH₂)ₘ₄Z²]ₘ₂—(CH₂)ₘ₃—Z³—, or —Z³—(CH₂)ₘ₃—[Z²(CH₂)ₘ₄]ₘ₂—Z¹—(CH₂)ₘ₁—;
m1, m2, and m3 are each independently an integer from 0 to 20;
m4 is an integer from 0 to 4;
p is an integer from 1 to 7;
r is an integer from 1 to 7;
R^{Z} is independently at each occurrence H or C₁-C₆ alkyl;
Z¹, Z², and Z³ are each independently absent (a bond), —O—, —S—, —NR^{L5}—, —C(O)—NR^{L5}—, or —NR^{L5}—C(O)—, wherein each R^{L5} is independently selected from the group consisting of hydrogen, C₁-C₆ alkyl, C₆-C₁₀ aryl, C₅-C₁₀ heteroaryl, C₃-C₈ cycloalkyl, and C₃-C₈ cycloheteroalkyl, each of which is optionally substituted by 1 to 3 groups selected from the group consisting of halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)R^{Z}, —C(O)NR^{Z}R^{Z}, —SO₃R^{Z}, —SR^{Z}, and —S(O)₁₋₂R^{Z};
R^{L1}, R^{L2}, R^{L3}, and R^{L4} are each independently selected from the group consisting of hydrogen, C₆-C₁₀ aryl, C₁-C₆ alkyl, C₃-C₈ cycloalkyl, C₅-C₁₀ heteroaryl, and C₃-C₈ cycloheteroalkyl, each of which are optionally substituted by 1 to 3 groups selected from the group consisting of halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, —S(O)₁₋₂R^{Z};
X is —C(R^{X})₃, —OR^{X}, N(R^{X})₂, —S—R^{X}, —S—S—R^{X}, —CH(SR^{X})₂, —C(O)—R^{X}, —C(O)—OR^{X}, —C(O)N(R^{X})₂, —C₆₋₁₀ aryl optionally substituted by 1 to 6 R^{X} groups, —NH—C(O)—R^{X}, or —NH—C(O)—N(R^{X})₂,wherein each occurrence of R^{X} is independently selected from the group consisting of H, halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)₁₋₂R^{Z};
with an alkyne of Formula (II): 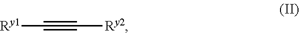
wherein:
R^{y1} and R^{y2} are selected from the group consisting of hydrogen, C₆-C₁₀ aryl, C₁-C₆ alkyl, C₃-C₈ cycloalkyl, C₅-C₁₀ heteroaryl, and C₃-C₈ cycloheteroalkyl, each of which are optionally substituted by 1 to 3 groups selected from the group consisting of halogen, —CN, —C(O)—R^{Z}, —O—C(O)—R^{Z}, —(CH₂)ᵣC(O)—O—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)₁₋₂R^{Z}, provided that at least one of R^{y1} and R^{y2} is not hydrogen;
or wherein R^{y1} and R^{y2} are fused to form an 8 to 13-membered cycloalkyl ring, which is optionally substituted by 1 to 3 groups selected from the group consisting of halogen, C₆-C₁₀ aryl, C₁-C₆ alkyl, C₃-C₈ cycloalkyl, C₅-C₁₀ heteroaryl, and C₃-C₈ cycloheteroalkyl, each of which are optionally substituted by 1 to 3 groups selected from the group consisting of H, halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)—₂R^{Z}.

2. The method of claim 1, wherein m is 0 or 1 and n is 0 or 1.

3. The method of claim 1, wherein R^{L} is —(CH₂)ₚ—, wherein p is an integer from 1 to 7.

4. The method of claim 1, wherein the compound of Formula (I) is:

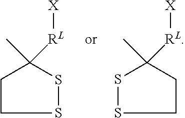

5. The method of claim 1, wherein R¹ is methyl.

6. The method of claim 1, wherein the compound of Formula (I) is:

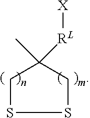

7. The method of claim 1, wherein the compound of Formula (I) is:

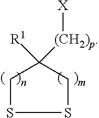

8. The method of claim 1, wherein the compound of Formula (I) is:

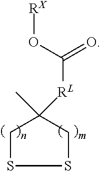

9. The method of claim 1, wherein the compound of Formula (I) is selected from the group consisting of:

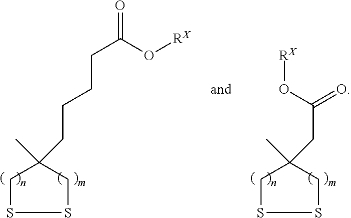

10. The method of claim 1, wherein the compound of Formula (I) is

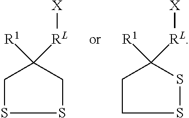

11. The method of claim 1, wherein the compound of Formula (I) is selected from the group consisting of:

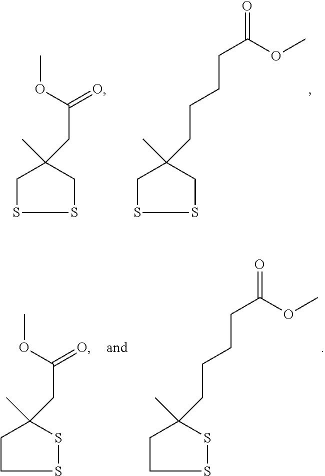

12. The method of claim 1, wherein X is selected from the group consisting of:

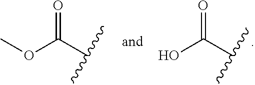

13. The method of claim 1, wherein R^{y2} is H.

14. The method of claim 1, wherein R^{y1} and R^{y2} are each independently selected from the group consisting of hydrogen, phenyl, methyl, and —(CH₂)ᵣC(O)—O—R^{Z}, wherein R^{Z} is C₁-C₆ alkyl.

15. The method of claim 1, wherein the alkyne of Formula (II) is selected from the group consisting of phenylacetylene, 1-octyne, propargyl acetate, methyl propargyl ether, cyclooctyne, ethyl propiolate, methyl propargylamine, 2-octyne, dimethylacetylenedicarboxylate, 1,9-decadiyne, ethyl phenylpropiolate, and diphenylacetylene.

16. The method of claim 1, wherein the polymer further comprises a compound of Formula (III): 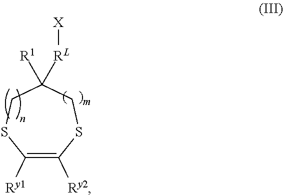
wherein the compound of Formula (III) is present in an amount of about 0.001 to about 20% (w/w) relative to the weight of the polymer.

17. The method of claim 1, wherein the contacting further comprises exposing the compound of Formula (I) to electromagnetic radiation or thermal radiation.

18. The method of claim 17, wherein the electromagnetic radiation is microwave radiation.

19. A polymer composition comprising a reaction product of a compound of Formula (I) and a compound of Formula (II):
wherein the compound of Formula (I) has the structure: 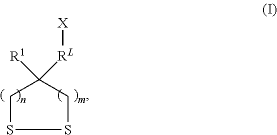
wherein:
m and n are integers and the sum of m and n is 2, 3, or 4;
R¹ is H or C₁-C₆ alkyl;
R^{L} is —(CH₂)ₚ—, —(OCH₂—CH₂)ₚ—, —(CHR^{L1})ₘ₁—O—(CHR^{L2}—CHR^{L3}—O)ₘ₂—(CHR^{L4})ₘ₃—C(O)—, —C(O)—(CHR^{L4})ₘ₃—(O—CHR^{L3}—CHR^{L2})ₘ₂—O—(CHR^{L1})ₘ₁—, —(CH₂)ₘ₁—Z¹—[(CH₂)ₘ₄Z²]ₘ₂—(CH₂)ₘ₃—Z³—, or
—Z³—(CH₂)ₘ₃—[Z²(CH₂)ₘ₄]ₘ₂—Z¹—(CH₂)ₘ₁—;
m1, m2, and m3 are each independently an integer from 0 to 20;
m4 is an integer from 0 to 4;
p is an integer from 1 to 7;
r is an integer from 1 to 7;
R^{Z} is independently at each occurrence H or C₁-C₆ alkyl;
Z¹, Z², and Z³ are each independently absent (a bond), —O—, —S—, —NR^{L5}—, —C(O)—NR^{L5}—, or —NR^{L5}—C(O)—, wherein each R^{L}5 is independently selected from the group consisting of hydrogen, C₁-C₆ alkyl, C₆-C₁₀ aryl, C₅-C₁₀ heteroaryl, C₃-C₈ cycloalkyl, and C₃-C₈ cycloheteroalkyl, each of which is optionally substituted by 1 to 3 groups selected from the group consisting of halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)₁₋₂R^{Z};
R^{L1}, R^{L2}, R^{L3}, and R^{L4} are each independently selected from the group consisting of hydrogen, C₆-C₁₀ aryl, C₁-C₆ alkyl, C₃-C₈ cycloalkyl, C₅-C₁₀ heteroaryl, and C₃-C₈ cycloheteroalkyl, each of which are optionally substituted by 1 to 3 groups selected from the group consisting of halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, —S(O)₁₋₂R^{Z};
X is —C(R^{X})₃, —OR^{X}, N(R^{X})₂, —S—R^{X}, —S—S—R^{X}, —CH(SR^{X})₂, —C(O)—R^{X}, —C(O)—OR^{X}, —C(O)N(R^{X})₂, —C₆₋₁₀ aryl optionally substituted by 1 to 6 R^{X} groups, —NH—C(O)—R^{X}, or —NH—C(O)—N(R^{X})₂,wherein each occurrence of R^{X} is independently selected from the group consisting of H, halogen, —CN, —C(O)—R^{Z}, —O—C(O)—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)₁₋₂R^{Z};
with the compound of Formula (II) has the structure: 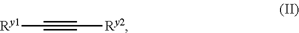
wherein:
R^{y1} and R^{y2} are selected from the group consisting of hydrogen, C₆-C₁₀ aryl, C₁-C₆ alkyl, C₃-C₈ cycloalkyl, C₅-C₁₀ heteroaryl, and C₃-C₈ cycloheteroalkyl, each of which are optionally substituted by 1 to 3 groups selected from the group consisting of halogen, —CN, —C(O)—R^{Z}, —O—C(O)—R^{Z}, —(CH₂)ᵣC(O)—O—R^{Z}, NR^{Z}R^{Z}, —NO₂, —OR^{Z}, —NR^{Z}R^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)₁₋₂R^{Z}, provided that at least one of R^{y1} and R^{y2} is not hydrogen;
or wherein R^{y1} and R^{y2} are fused to form an 8 to 13-membered cycloalkyl ring, which is optionally substituted by 1 to 3 groups selected from the group consisting of halogen, C₆-C₁₀ aryl, C₁-C₆ alkyl, C₃-C₈ cycloalkyl, C₅-C₁₀ heteroaryl, and C₃-C₈ cycloheteroalkyl, each of which are optionally substituted by 1 to 3 groups selected from the group consisting of H, halogen, —CN, —C(O)—R^{Z}, —O—C(O)—R^{Z}, NR^{Z}R^{Z}, —NO₂, —OR^{Z}, —NR^{Z}, —NR^{Z}—C(O)R^{Z}, —NR^{Z}—SO₂R^{Z}, —C(O)OR^{Z}, —C(O)NR^{Z}R^{Z}, —SO₃R^{Z}, —SR^{Z}, and —S(O)₁₋₂R^{Z}.

20. The polymer composition of claim 19, wherein the polymer composition further comprises about 0.001 to about 20% (w/w) of a compound of Formula (III):

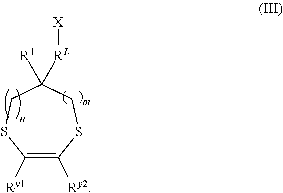

21. The polymer composition of claim 19, wherein the polymer has an average molecular weight from about 1,000 Da to about 100,000 Da.

22. The polymer composition of claim 19, wherein the polymer composition has a refractive index of about 1.45 to about 1.60.

23. The polymer composition of claim 19, wherein the polymer is optically isotropic.

24. An article of manufacture comprising the polymer composition of claim 19, wherein the article comprises a lens, a waveguide, a lithograph, a hologram, a window, a prism, or a mirror, or combinations thereof.
